(19) United States
(12) Patent Application Publication
(10) Pub. No.: US 2011/0307561 A1
(43) Pub. Date: Dec. 15, 2011

(54) SYSTEM AND APPARATUS FOR POWER-EFFICIENTLY DELIVERING WEBPAGE CONTENTS IN A BROADCAST NETWORK

(75) Inventors: QIANG GAO, San Diego, CA (US); Min Dai, San Diego, CA (US); Qi Xue, San Diego, CA (US)

(73) Assignee: QUALCOMM Incorporated, San Diego, CA (US)

(21) Appl. No.: 12/815,053

(22) Filed: Jun. 14, 2010

(51) Int. Cl. G06F 15/16

(52) U.S. Cl. 709/206; 709/219

(57) ABSTRACT

Embodiments provide bandwidth efficient mechanisms for delivering rich media content, such as webpages, to receiver devices via a multimedia broadcast network. Content, such as selected webpages, is broadcast as disassembled content elements via the broadcast network. To enable reception, the disassembled content elements are broadcast according to a broadcast schedule that is communicated in an overhead content description flow, such as a catalog file. Receiver devices receive the catalog file and use the metadata information to selectively receive disassembled content and store the content elements in memory. When a user requests access to the content (e.g., a webpage via a web browser), an application operating in the receiver device assembles the requested content from the previously received and stored disassembled content elements, and passes the assembled webpage to a using or rendering application.

### TECHNICAL FIELD

The present application relates generally to wireless delivery of network content, and more particularly to efficient methods for delivering and accessing website content to wireless receivers via a broadcast network.

### BACKGROUND

Wireless communication technologies have seen explosive growth over the past few years. This growth has been fueled by wireless services providing freedom of movement to the mobile public, and cutting the tether to hardwired communication systems. As a result of service enhancements, the popularity of wireless services is expected to continue to grow rapidly. A recent addition to wireless communication services has been the ability to broadcast television and other content to mobile devices. Mobile multimedia broadcast services allow users to view TV programming, as well as receive mobile editions of news, entertainment, sports, business, and other programming, using their cell phone or other wireless mobile device configured to receive the mobile broadcast transmissions.

### SUMMARY

The various aspects include a method for broadcasting content in a mobile multimedia broadcast system, in which the method includes assembling a content element into a content element package suitable for broadcast via a broadcast network, broadcasting a content description message describing the content element and identifying a time at which the content element package will be broadcast, and broadcasting the content element package at the identified time. In an aspect of the method, the content element may be a webpage content element, and the content element package may be a webpage content element package.

The various aspects include a multimedia broadcast network including a broadcast transmission system and a server coupled to the broadcast transmission system, in which the servicer is configured with server-executable instructions to perform operations of the above described method.

The various aspects include a multimedia broadcast network including means for assembling a content element into a content element package suitable for broadcast via the broadcast network, means generating a content description message describing the content element and identifying a time at which the content element package will be broadcast by the broadcast transmission system, means for broadcasting the generated content description message to the transmission system for broadcast, and means for broadcasting the content element package at the identified time.

The various aspects include a non-transitory computer readable storage medium having stored thereon server-executable instructions configured to cause a server of a multimedia broadcast network to perform operations of the above described method.

The various aspects further include a receiver device method for accessing a rich media content in a receiver device configured to receive transmissions from a broadcast network, the method including receiving in the receiver device a broadcast content description message describing a content element and identifying a time at which a package including the content element will be broadcast, determining in the receiver device from at least some of the information included in the received content description message whether the package including the content element should be received, receiving the package including the content element at the identified broadcast time when it is determined that the content element should be received, storing the received content in memory of the receiver device, receiving a request to access the content in the receiver device, and rendering the requested content using an application resident in the receiver device. In an aspect of the receiver device method, the content element may be a webpage content element, the content element package may be a webpage content element package, receiving a request to access the content in the receiver device may include receiving a request to access a webpage in the receiver device, and rendering the requested content using an application resident in the receiver device may include generating the requested webpage in a web server application operating in the receiver device using the stored webpage content element and providing the generated requested webpage to a web browser operating in the receiver device. In an aspect of the receiver device method, generating the requested webpage may include obtaining a template for the requested webpage from memory in the receiver device, and applying in the receiver device to the obtained template to the stored webpage content element. In an aspect the receiver device method may further include receiving the template for the requested webpage from the broadcast network and storing the received template in memory in the receiver device. In an aspect of the receiver device method, generating the requested webpage may include loading from memory in the receiver device a program for execution on the web server of the receiver device, the program being configured to generate the requested webpage according to logic implemented in the program, processing the stored webpage content element in the program, and receiving the program for the requested webpage from the broadcast network and storing the received template in memory in the receiver device. In an aspect of the receiver device method, determining whether the package including the webpage content element should be received may be based at least in part upon an identifier associated with the webpage content element.

In an aspect the receiver device method may further include receiving a user request to access a website (e.g., an Internet or local network website), and using an identifier of the requested website as the identifier associated with the webpage content element for determining whether the package including the webpage content element should be received, in which the identifier associated with the webpage content element is not a URL for the requested website.

In an aspect the receiver device method may further include receiving a user request to access a web flow of the broadcast network broadcasting content of the requested website, and using an identifier of the requested website as the identifier associated with the webpage content element for determining whether the package including the webpage content element should be received.

In an aspect the receiver device method may further include determining in the receiver device from at least some of the information included in the received content description message a version of the webpage content element that will be broadcast, and comparing the version of the webpage content element that will be broadcast to a version of a webpage content element stored in memory of the receiver device, in which determining whether the package including the webpage content element should be received may be based at least in part upon whether the version of the webpage content element that will be broadcast is newer than the version of the webpage content element stored in memory of the receiver device.

In an aspect of the receiver device method, the webpage content element may include an address for accessing the requested website via a network which may be different from the identifier of the requested website, in which the method may further include determining whether a unicast network connection is available to the receiver device, accessing a remote server supporting the requested website via the unicast network connection when it is determined that a unicast network connection is available to the receiver device, requesting a download of webpage content elements, and storing webpage content elements received from the requested website via the unicast network connection.

In an aspect the receiver device method may further include requesting from the remote server supporting the requested website a list of webpages available at the requested website when it is determined that a unicast network connection is available to the receiver device, generating and displaying in the receiver device a list of webpages corresponding to the requested website, receiving a user input selecting one of the listed webpages, and determining whether the selected one of the listed webpages is supported by webpage elements stored in memory of the receiver device, in which requesting a download of webpage content elements may be accomplished when it is determined that the selected one of the listed webpages is supported by webpage elements stored in memory of the receiver device. In an aspect of the receiver device method, requesting from the remote server supporting the requested website a list of webpages available at the requested website may include transmitting to the remote server supporting the requested website a list of webpages supported by webpage elements stored in memory of the receiver device, and receiving from the remote server via the unicast network a list of missing webpages which are available at the requested website but not included in the list of webpages supported by webpage elements stored in memory of the receiver device, in which generating and displaying in the receiver device a list of webpages corresponding to the requested website may include generating the list of webpages corresponding to the requested website based on a combination of the list of webpages supported by webpage elements stored in memory of the receiver device and the list of missing received webpages.

In an aspect of the receiver device method, the identifier associated with the webpage content element may include a web flow identifier. In an aspect of the receiver device method, the program for the requested webpage may include an address of a remote server which may be contacted via a network, wherein the address of a remote server is different from the web flow identifier.

In an aspect the receiver device method may further include determining whether a unicast network connection is available to the receiver device, accessing a web content server of the broadcast network via the unicast network connection when it is determined that a unicast network connection is available to the receiver device, requesting a download of webpage content elements associated with the requested web flow from the web content server, and storing webpage content elements received from the web content server via the unicast network connection.

In an aspect the receiver device method may further include determining whether an age of the stored webpage content element exceeds a threshold value prior to generating the requested webpage, determining whether a unicast network connection is available to the receiver device when it is determined that the age of the stored webpage content exceeds the threshold value, accessing the requested website via the unicast network connection when it is determined that a unicast network connection is available to the receiver device, downloading an updated webpage content element from the requested website via the unicast network connection, and storing the updated webpage content element in the memory of the receiver device, in which generating the requested webpage in the web server application operating in the receiver device using the stored webpage content element may use a most recently stored webpage content element.

The various aspects include a communication system including a wireless multimedia broadcast network, a wireless unicast network and a receiver device, in which the wireless multimedia broadcast network is configured to perform operations including assembling a content element into a content element package suitable for broadcast via a broadcast network, broadcasting a content description message describing the content element and identifying a time at which the content element package will be broadcast, and broadcasting the content element package at the identified time, and the receiver device includes a processor configured to perform operations of the methods described above.

The various aspects include a receiver device including a processor, a broadcast receiver circuit coupled to the processor, a unicast transceiver coupled to the processor and a memory coupled to the processor, in which the processor is configured with processor-executable instructions to perform operations of the methods described above.

The various aspects include a receiver device including means for accomplishing the operations of the methods described above.

The various aspects include a non-transitory processor-readable storage medium having stored thereon processor-executable instructions configured to cause a processor of a receiver device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a mobile multimedia broadcast communication system suitable for use in an embodiment.

FIG. 2 is an illustration of a webpage illustrating how content elements are combined to generate a webpage.

FIG. 3 is a communication flow diagram illustrating prior art communications and processes involved in delivering a webpage to a wireless device.

FIG. 4 is a communication flow diagram illustrating communications and processes for enabling access to webpages according to an embodiment.

FIG. 5 is a communication system block diagram of a mobile multimedia broadcast system illustrating content delivery to mobile devices.

FIG. 6 is a timeline illustration of an example relationship between broadcast content flows and overhead content description metadata flows according to an embodiment.

FIG. 7 is a process flow diagram of an embodiment method for delivering Internet webpage via a broadcast network.

FIG. 8 is a message flow diagram of example communications involved in the delivery of Internet webpage content to receiver devices according to an embodiment.

FIG. 9 is a process flow diagram of an embodiment method for receiving Internet webpages via a broadcast network.

FIG. 10 is a process flow diagram of an embodiment method for displaying a webpage on a receiver device from content received from a broadcast network with updates received via a unicast network.

FIG. 11 is a process flow diagram of an embodiment method for accessing webpages from local memory received via a broadcast network or a unicast network.

FIG. 12 is a component block diagram of a mobile device suitable for use in an embodiment.

FIG. 13 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “receiver device” are used interchangeably herein to refer to any one or all of personal mobile television receivers (e.g., FLO TV® related devices), cellular telephones, automobile mobile television receivers, personal data assistants (PDA's), palm-top computers, wireless electronic mail receivers (e.g., the Blackberry® and Treo® devices), multimedia Internet enabled cellular telephones (e.g., the Blackberry Storm®), and similar personal electronic devices which include a programmable processor and memory and mobile multimedia broadcast receiver circuitry for receiving and processing mobile multimedia broadcast transmissions.

The word “broadcast” is used herein to mean the transmission of data (information packets) so that it can be received by a large number of receiving devices simultaneously. Examples of a broadcast message are mobile television service broadcast signals, including content broadcasts (content flow) and overhead information broadcasts (overhead flow) such as metadata messages.

The word “unicast” is used herein to refer to a wireless data transmission that is directed to a single receiver device. In contrast to a broadcast network, a “unicast network” refers to a wireless communication network that sends and receives transmissions to and from individual wireless communication devices. Examples of unicast networks that may be used with the various embodiments include cellular communication networks (e.g., third generation (3G) cellular data networks), WiFi networks, and WiMax networks.

The word “web server” is used herein to mean an application or group of applications capable of receiving a Hypertext Transfer Protocol (HTTP) request and returning an appropriate HTTP response, such as providing a Hypertext Markup Language (HTML) file. A web server may include middleware or an application portion, such as a J2EE® server, an ASP® server, a PHP module, a PERL interpreter, or similar functionality. A web server may also include a data storage portion, such as a database management system (DBMS) or local file store. A web server may be implemented within a conventional server, but in the various embodiments a web server is also implemented within a receiver device.

The various embodiments provide bandwidth efficient mechanisms for delivering data to receiver devices via a wireless multimedia broadcast network so that the data can be assembled in the receiver device by a local application. The various embodiments may be particularly useful for delivering Internet webpages to mobile devices since a wireless broadcast network provides an efficient delivery mechanism that can be levered for delivering popular Internet websites. Data files, such as webpage contents of selected webpages such as may be hosted on local networks or the Internet, are broadcast as disassembled content elements via the broadcast network. To enable reception, the disassembled content elements are broadcast according to a broadcast schedule that is communicated in an overhead content description flow, such as an electronic catalog. Receiver devices receive the overhead content description flow and use the metadata information to selectively receive the disassembled webpage content and store the content elements in memory. When a user requests access to a file, such as an Internet webpage via a web browser, a local application, such as a web server application operating in the receiver device, assembles the requested file (e.g., webpage) from the previously received and stored disassembled content elements (e.g., webpage content elements), and passes the assembled file (e.g., requested webpage) to the requesting application (e.g., a web browser). The local application then uses the file as if it had been downloaded directly from a network connection. In the case of web content, the local application is the web browser which presents the requested webpage to the user as if it had been received from a remote Internet server. The local web server may combine webpage elements received from both broadcast and unicast networks and present the documents (e.g., webpages) to the user in a seamless manner. In a typical situation, most of the data may be received from the broadcast network and only a small portion of the webpage content from the unicast network.

The various embodiments have a wide variety of potential applications for delivering rich media content to mobile receiver devices via a broadcast network. The large bandwidth of broadcast networks can be leveraged to transmit large media content files to receiver devices. By accomplishing the assembly of rich media content into a form that is presented to a user of utilized by a local application within receiver device, the delivery of rich media content in the form of broadcast content elements can more efficiently utilize bandwidth and enable receiver devices to conserve battery power. This is especially the case when portions of the rich media content are updated regularly while other portions are updated infrequently or not at all, since only the updated media content elements need to be broadcast regularly and receiver devices do not have to activate their receiver circuitry to receive media content elements already received and stored in memory. Once received and stored in memory, the media content elements may be used by a local application to use or present the content to the user in the required or preferred format, such as webpages, native application content, e-books, etc. Since the downloading and storage of the media content elements occurs in the background, the user need not be aware that the content is being received. Thus, the content appears to be instantly accessed when requested by the user since it is recalled from local memory.

A particularly useful application of the various embodiments is the delivery and rendering of frequently accessed web pages. Employing the various embodiments, commonly accessed webpages can be displayed to a user via a web browser without the delay associated with downloading webpage content. Since the disaggregated webpage content can be broadcast during periods of greater availability of broadcast bandwidth (i.e., during off-peak hours), the embodiments enable efficient utilization of wireless bandwidth to enable webpage delivery via a broadcast network instead of via a unicast network. Since a large portion of Internet traffic involves a limited number of popular websites, the various embodiments enable delivery of the most frequently accessed webpages to a large number of mobile devices in a bandwidth-efficient and power-efficient manner. Since the web server is hosted on the mobile device, the various embodiments can dynamically generate personalized web pages from the broadcast content elements which can be displayed using a standard browser. If content elements for a requested webpage have not been received via the broadcast network, the receiver device may request delivery of the webpage via conventional wireless Internet access protocols and communication systems.

For ease of reference, the various embodiments are described below using the example application of Internet web content delivery. This application illustrates functioning of the various embodiments using common terminology. However, the following descriptions are not intended to limit the embodiments to Internet web content delivery. One having ordinary skill in the art would appreciate that the various embodiments may also be used for delivering a variety of rich media content. Accordingly, the scope of the claims should not be limited to Internet web content delivery and reception unless specifically recited.

A number of different mobile broadcast television services and broadcast standards are available or contemplated in the future, all of which may implement and benefit from the various embodiments. Such services and standards include, e.g., Open Mobile Alliance Mobile Broadcast Services Enabler Suite (OMA BCAST), MediaFLO, Digital Video Broadcast IP Datacasting (DVB-IPDC), Digital Video Broadcasting-Handheld (DVB-H), Digital Video Broadcasting-Satellite services to Handhelds (DVB-SH), Digital Video Broadcasting-Handheld 2 (DVB-H2), Advanced Television Systems Committee-Mobile/Handheld (ATSC-M/H), and China Multimedia Mobile Broadcasting (CMMB).

Popular web content may be suitable for distribution over a broadcast wireless network (versus a unicast network) since a large portion of common web page requests are directed to a relatively small number of Internet content providers. For example, popular web sites providing frequently accessed content, such as news, weather, traffic, current events, and public announcements, may be delivered to mobile devices using the various embodiments, enabling the content to be broadcast efficiently (in terms of bandwidth utilization and receiver device battery power consumption) while providing users with near-instant access to web pages. A broadcast network provider, working with a small number of popular web content providers, can provide a sufficient variety of content using the efficient website data delivery mechanisms of the various embodiments. A broadcast network, such as those incorporating Qualcomm's MediaFLO® technologies, can efficiently deliver the web content according to the various embodiments to an unlimited number of users. When a mobile receiver device user accesses a broadcast website (e.g., by entering in the URL of the website), the web server functioning within the receiver device may rapidly generate the requested website from content modules stored in memory without delays associated with requesting and receiving the web page from a remote server. If a user accesses a website to request display of a web page that is not broadcast according to the embodiments, the user's receiver device may obtain the requested web page from a remote server via a unicast wireless network.

In the various embodiments, the receiver device may automatically monitor the broadcast network for scheduled broadcasts of webpage content elements, and selectively receive and store webpage content elements for websites that the user is interested in receiving. In a typical embodiment, this process may be done in the background. When a user of the receiver device enters a command to view a particular webpage (e.g., by entering the websites name or selecting the corresponding URL), the web server application within the receiver device assembles the requested webpage and presents it to a standard web browser or other application (e.g., a widget) for viewing. The presented web content may be dynamic and interactive, and have the same look-and-feel as the regular webpage downloaded from the Internet via a unicast wireless network or a wired network connection. Since the webpage content elements are locally stored, the requested webpage may be assembled and displayed very rapidly. Thus, from the user's perspective, the receiver device appears to have very high-speed Internet access capability for webpages that were previously received as disassembled webpage content elements. This may provide a significant improvement in the user experience over traditional mobile web browsers, since web pages typically take 20 seconds or more to download over a 3G link, which is in addition to any server delays.

By transmitting webpage content as disassembled elements, the various embodiments reduce the amount of information that needs to be broadcast to and saved by receiver devices. One reason for this is that webpages typically reuse large amounts of content each time they are rendered. Popular webpages tend to reuse standard graphics, e.g., logos, banners and stock images. Also, most commercial webpages assemble content according to standard templates which specify where individual content elements are to be presented on the page and the manner in which it should be displayed (e.g., font size and color), as well as background colors, shading and textures. In the various embodiments, webpages may also be assembled using known mechanisms other than templates, such as a program running on the web server on the receiver device to generate webpages according to logic implemented in the program. Such programs may be preloaded on the receiver device, received via period transmission by the broadcast network, from a unicast network, or via a software upload, such as from a processor-readable storage medium. In the various embodiments, such reused graphics and templates can be broadcast infrequently or downloaded one time via a unicast network (such as part of a website registration process) and stored in memory of the receiver devices. Thereafter, only the content elements (e.g., text files) need to be broadcast to enable receiver devices to present the webpages in response to user access requests. The web server operating in the receiver device assembles the requested webpage into the necessary HTML document using the pre-stored templates, standard graphics and content files, and locally provides the assembled webpage to the web browser. Thus, accessing a common webpage does not require the entire webpage to be transmitted as a complete HTML document. Further, since webpage content elements are broadcast to all receiver devices, the amount of bandwidth consumed to deliver those websites is fixed no matter how many times users access any one or all of the websites.

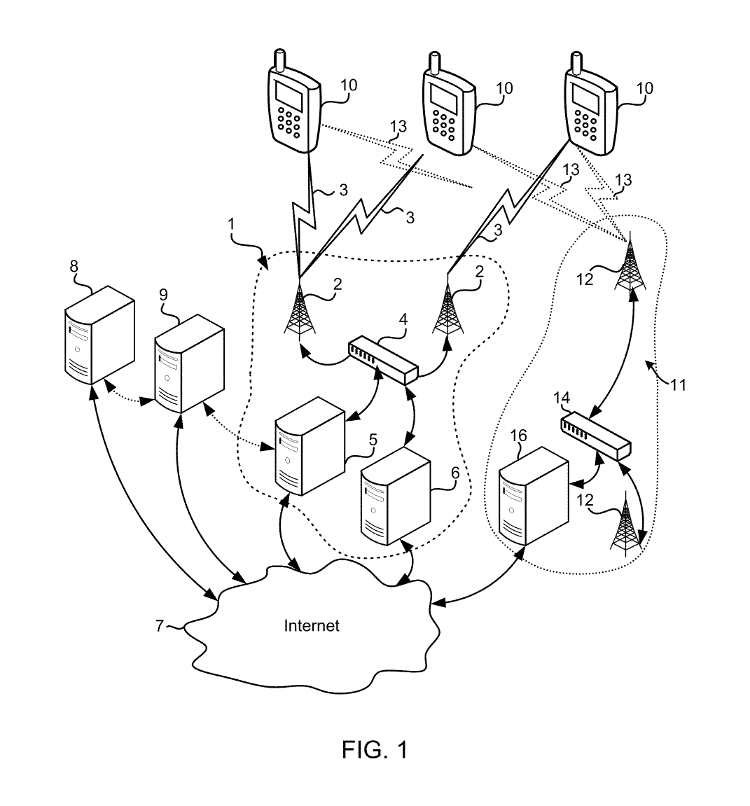

The various embodiments may be implemented within a variety of mobile multi-media broadcast systems, an example of which is illustrated in FIG. 1. A mobile multimedia broadcast network 1, such as a MediaFLO® broadcast network, typically includes a plurality of broadcast transmitters 2 controlled by a mobile broadcast network control center which is referred to herein as a broadcast operation center 4 (or “BOC” in the figures). The broadcast network 1 broadcasts content from the broadcast transmitters 2 as mobile broadcast transmissions 3 for reception by mobile devices 10, such as mobile television receivers, smart phones, cellular phones, personal digital assistants (PDA), pad computers, interactive game devices, notebooks, smartbooks, netbooks, data processing apparatus, or other such electronic devices. Within the mobile broadcast network control center 4 will typically be one or more servers 6 which may be configured to manage the scheduling of content broadcasts, generation of electronic service guides and catalog messages regarding the content broadcasts, and generation of metadata messages for broadcast via the overhead flow of the multimedia broadcast network 1. One or more servers 6 may also include connections to an external network, such as the Internet 7, through which the server 6 may receive content feeds from content provider servers 8. One or more servers 6 may be configured to receive content from content provider servers 8, determine information about the received content to be included in metadata, determine a schedule for broadcast of the content in content batches, and generate an electronic service guide, catalogs of content broadcasts, and other overhead flows for broadcast to receiver devices 10.

As part of this content delivery system, the mobile broadcast network 1 may also include a web content server 5 for managing webpage content elements for broadcast via the mobile broadcast network 1 according to the various embodiments. The web content server 5 may receive webpage content elements, such as text files, images, graphics, CSS files, JavaScript® files, JPEG media files, Flash® media files, and templates, from a website hosting server 9, either via a direct network connection or an indirect network connection, such as the Internet 7. In some implementations, the web content server 5 may periodically access a website hosting server 9 to download the latest webpage content. In some implementations the website hosting server 9 may periodically push updated webpage content elements to the web content server 5. In some implementations, the web content server 5 may receive updated webpage content elements both by accessing websites and by receiving content pushed to it by website hosting servers 9. The generation of web content in the website hosting server 9 may be accomplished in the ordinary manner that website content is generated and hosted.

In addition to the mobile multimedia broadcast network 1, receiver devices 10 may also be configured for duplex communication via a unicast network 11, such as a 3G cellular telephone network or a WiFi wireless network (e.g., a WiFi “hotspot”). A typical cellular telephone network includes a plurality of cellular base stations 12 coupled to a network operations center 14, which operates to connect voice and data calls between mobile devices 10 and other network destinations, such as via telephone land lines (e.g., a POTS network, not shown) and the Internet 7. Communications between mobile devices 10 and the unicast network 11 may be accomplished via two-way wireless communication links 13, such as 3G, CDMA, TDMA, and other cellular telephone communication technologies, as well as wireless wide area network such as WiFi, WiMax, etc. To facilitate Internet data communications, the unicast network 11 alone will typically include one or more servers 16 coupled to or within the network operations center 14 that provide a connection to the Internet 7. Mobile devices 10 may communicate with the broadcast network 1 via the unicast network 11, such as via an IP data call to a broadcast network server 6 by way of the Internet 7, such as for purposes of subscribing to broadcast services (e.g., subscribing to broadcast web services) and reporting user viewing patterns. Additionally, mobile device users can access the Internet 7 via the unicast network 11, such as to download webpages that are not broadcast per one of the various embodiments. The unicast network 11 may also be used to subscribe to broadcast web services enabled by the various embodiments, including downloading of templates, stock graphics and other content elements that are reused by subscribed-to websites.

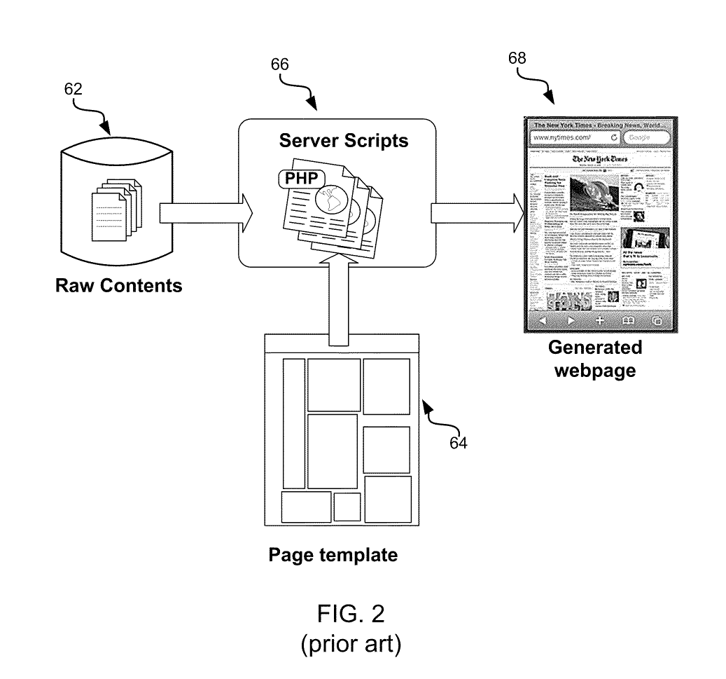

An example of how a typical web server processes web content to create a web page is illustrated in FIG. 2. A generated webpage 68 may be any document capable of being viewed or executed by a web browser. A webpage 68 is often a single HTML formatted file, but may be a single file of another format such as XML, JavaScript®, JPEG, MPEG, Flash® or PDF® or it may be a file, such as an HTML file, that relies on additional files. For example, a typical webpage 68 comprises an HTML file, one or more CSS and JavaScript® files, one or more JPEG media files and one or more Flash® media files. A webpage 68 may be static or dynamically generated. A static webpage 68 is generally a web page that is stored on the website hosting server in the same format as it is delivered to the end user. However, the majority of popular web content is dynamically generated. FIG. 2 illustrates components that a web server can utilize to dynamically generate a webpage 68. The server, upon a request for a webpage, may run server side scripts 66 to generate webpages 68 based on the raw content 62 in the database, the page templates 64, and parameters specified in the user's request, and returns the generated webpage 68 to the user via a network connection.

The server side scripts 66 often comprise the middleware or application level of a web site and for a typical ecommerce website or similarly complex web application, the server side scripts 66 contains a large portion of the code required to process transactions. In a typical content-based website, the server side scripts 66 may perform a more limited role such as selecting the appropriate content based on user preferences (e.g., selecting which news stories to display on the main page based on past browsing history). In a further simplified example, the server side scripts 66 may merely query a database for the most up to date information, but not customize the webpage 68 based on the user. The server side scripts 66 may be script files containing code in languages such as PHP, ASP®, PERL, PYTHON, but they may be compiled code originally written in a language such as JSP®, ASP.NET®, Java® or C++, or a combination of scripted and compiled code.

The page templates 64 may be utilized for properly formatting the web page 68. A typical website may have many page templates 64, including some that are only executed when generating a webpage 68 intended for display on a mobile device. While the page templates 64 may include static HTML code segments, they often include server-side code such as PHP. The distinction between a page template 64, a server side scripts 66 and raw content 62 is primarily functional in that both the page template 64 and the raw content 62 may be executable computer code rather than pure data, or a combination thereof. As used herein, a page template 64 refers to the data and code primarily used to generate a web page while raw content 62 refers to the data and code which is frequently and/or periodically updated and may be suitable for use in various circumstances beyond web sites.

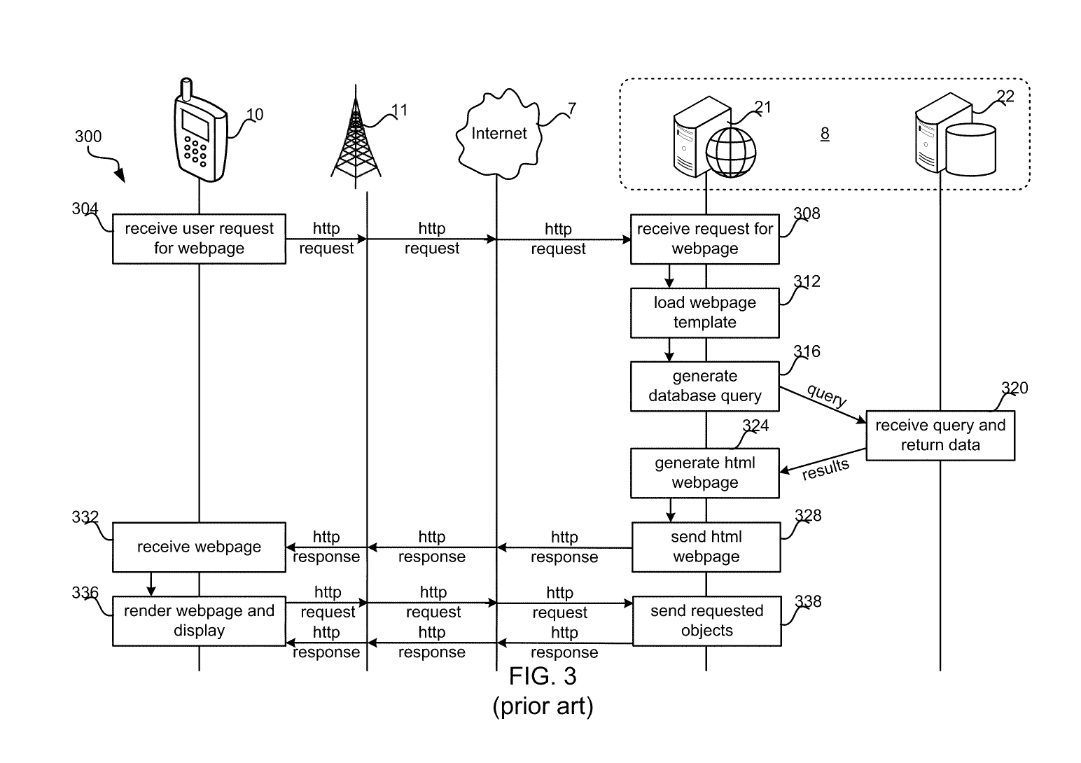

An example of a conventional process by which a web content provider can dynamically generate a web page based on a user request is illustrated in FIG. 3, which shows process steps and message exchanges among various components within a unicast wireless communication. A conventional unicast communication system providing users access to websites via a wireless network may include a mobile device 10 connected to a unicast network 11 for access to the Internet 7, and by a web content provider server 5, which includes a web server 21 and a database server 22. In method 300, the mobile device 10 may receive a user request for a webpage in step 304. The mobile device 10 may generate a message in the form of an HTTP request, which is sent to the web content provider server 6 via the unicast network 11 and the Internet 7. The web content provider server 5 may receive the incoming HTTP request in a web server 21 in step 308. The web server 21 may load the appropriate webpage template in step 312, and begin executing the server side scripts. The template scripts may require data, such as the latest news headlines, and a database query (e.g., a SQL query) may be generated in step 316. The query may be sent to the database server 22 via a database query protocol, such as JDBC. The database server 22 may receive the query, process the query, prepare and format the results and return the data in step 322, such as via a database response protocol (e.g., JDBC). The web server 21 may receive the results and generate an HTML webpage based on the data in step 324, and send the HTML webpage to the mobile device 10 in the form of an HTTP response in step 328. The mobile device 10 may receive the webpage in step 332, and render the webpage for display in step 336. It should be noted that for a typical webpage, receiving the HTML webpage is merely the first step in the process of displaying the content, as a typical HTML webpage often includes imbedded media files, such as photographs, or relies on external CSS and JavaScript files. Typically, the mobile device 10 will process the received HTML to determine which additional objects should be fetched and automatically request the documents via HTTP from the web server 21, which returns the requested objects in step 338. Many of these additional objects will be static files that require little, if any, server-side processing, but others, such as multimedia files, may be dynamically generated.

As FIG. 3 illustrates, in a conventional webpage delivery process, all of the contents of the webpage are transmitted to the requesting mobile device 10 in form for rendering each time the webpage is accessed by any user.

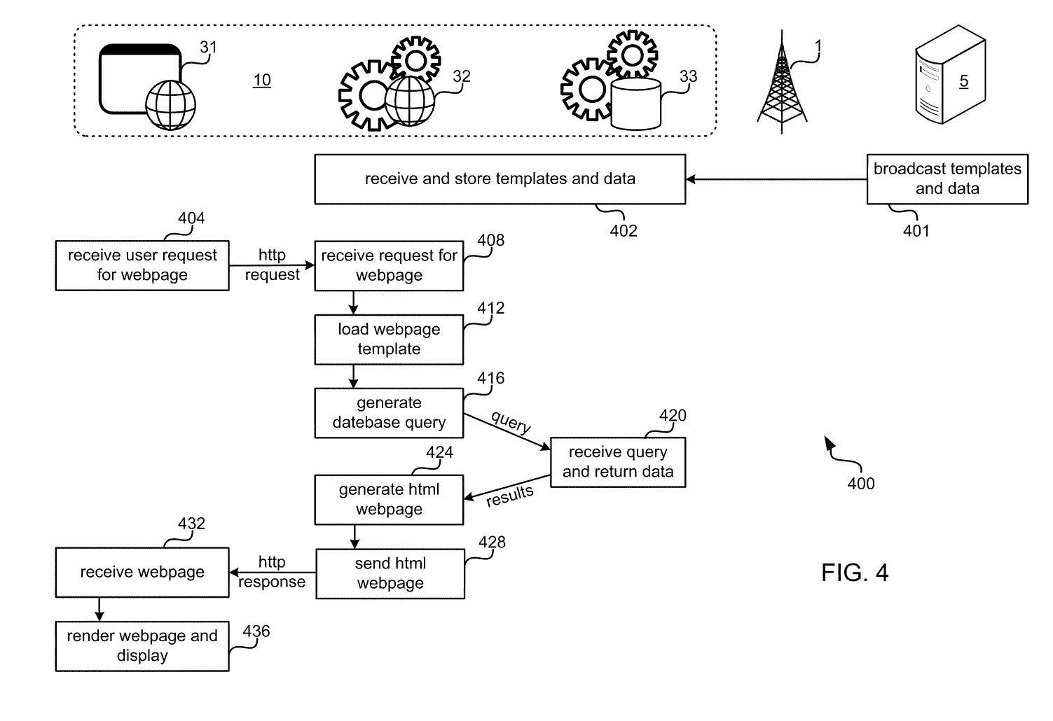

In contrast to the conventional webpage delivery process illustrated in FIG. 3, the various embodiments assemble webpages within a web server application 32 hosted within the mobile device 10. An overview 400 of an embodiment method for generating webpages in a mobile device using broadcast webpage content elements is illustrated in FIG. 4, which shows process steps and message exchanges among the various elements of a broadcast communication network. The various embodiments utilize a local web server 32 and a local data store 33 on the mobile device 10 to provide the user with broadcast web service. The web content provider server 5 may broadcast, via the broadcast network 1, webpage content elements comprising the templates and data required to generate a webpage in step 401, which are selectively received and stored by the mobile device 10 in step 402. Methods for broadcasting and selectively receiving webpage content elements are described in more detail below. A processor within the mobile device 10 may be configured with application software including a web browser 31 and a local web server, and may be coupled to a local data store 33. Some time after receiving webpage content elements, step 402, the web browser 31 operating within the mobile device 10 may receive a user request for a web page in step 404, such as from the user entering a website name (e.g., “CNN”), selecting a website from a list or menu, or activating a hyperlink within a displayed document. In response, the web browser 31 may generate an HTTP request, which the mobile device processor may send to the local web server 32 via an internal data bus or software relay. In some implementations, the web site hosted by the “local” web server will have a “local” URL (e.g., http://localhost:8008/cnn/tech). In such implementations, a program for the local site on the local Web server may inform the receiver device of the appropriate remote site that should be contacted. In some implementations, the URL for the remote server that should be contacted to receive content via the unicast network may be included within the program for the website. The URL may also be included in the information regarding webpage content that is transmitted as part of the overhead information. The local web server 32 may receive the request for a webpage in step 408, and load the appropriate webpage template or program in step 412. The local web server 32 may process the template or program and, if required to generate the requested webpage, generate a database query, such as a SQL query, in step 416. The database query in the form of a database query protocol (e.g., JDBC) may be sent over a data bus or a software relay to the local data store 33 within the mobile device, which receives the query and returns the appropriate data in step 420. The local web server 32 may receive the results and generate the HTML webpage based on the template using the local data in step 424, and send the generated HTML webpage to the web browser 31 in step 428. The web browser 31 may receive the webpage via HTTP response in step 432, and render the webpage for display in step 436. If the rendering of the webpage requires accessing objects stored in the local data store 33, the browser 31 may send requests for the required objects to the database and receive the requested objects.

The various embodiments may utilize a web browser 31, a web server 32, and a local data store 33 to dynamically generate web content, as shown in FIG. 4. However, the various process steps may be accomplished by any combination of applications. In an embodiment, the functions of the web browser 31, the web server 32 and the local data store 33 may be performed by a single application. In a further embodiment, the local data store 33 and local web server 32 may be a single application. Additionally, the web browser 31 may be a web browser capable of downloading and rendering Internet web pages, or it may be an application limited to interfacing with the local web server 32.

Further, webpages may be generated by the local application (e.g., local web server) using methods other than templates. For example, webpages may also be assembled by a program running on the local web server on the receiver device to generate webpages according to logic implemented in the program. Such programs may be preloaded on the receiver device, received via period transmission by the broadcast network, from a unicast network, or via a software upload, such as from a processor-readable storage medium. Such programs for particular webpage may include an address of a remote server which may be contacted via a network. This address of the remote server may be different from the web flow identifier and the Internet URL for the website.

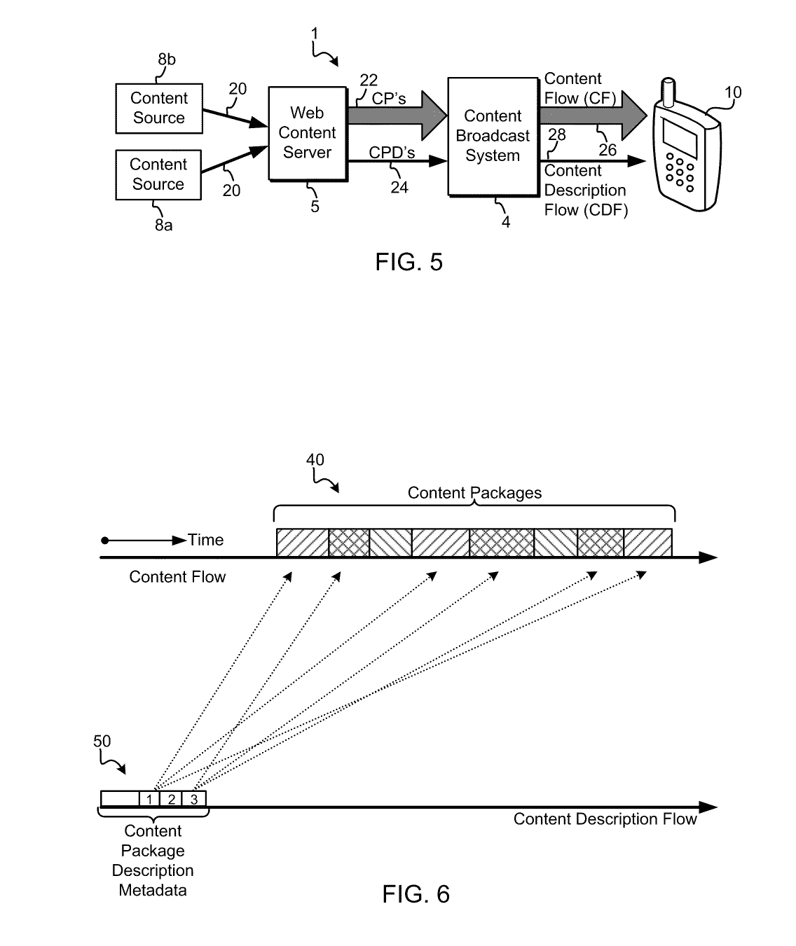

To broadcast webpage content elements to mobile devices, the various embodiments may utilize methods similar to how other content is broadcast to mobile receiver devices in a mobile multimedia broadcast network. FIG. 5 illustrates an overview of information flows within a mobile multimedia broadcast network 1 that may be used for delivering webpage content elements mobile devices 10 broadcast transmissions. As mentioned above, a mobile multimedia broadcast network 1 may receive webpage content elements (e.g., web templates or programs, graphics, images, dynamic data and executable scripts) from a number of website hosting servers 9a, 9b. Such content may be provided to a web content server 5 within a mobile multimedia broadcast network 1 via data networks 20 (e.g., the Internet 7). The web content server 5 may store such content in a database and schedule the content for broadcast. In scheduling content for broadcast, the content manager server 6 determines what will be broadcast when and on which network address. As part of scheduling, the web content server 5 may format the webpage content elements into content packages (CPs) suitable for broadcast. The web content server 5 can also extract information about the webpage content elements, such as the corresponding webpage name, local or remote URL, object identifier or file name, version number, media type (e.g., text, PDF, JPEG, FLASH, JavaScript, etc.), element age or date/time of creation, and other information about the webpage content elements that may be useful for enabling receiver devices to determine whether to receive the content packages from a broadcast stream. The web content server 5 may coordinate with the broadcast content system 4 to determine scheduled broadcast times for webpage content elements packages, as well as other broadcast information required for reception, such as the identifier of the flow (i.e., flow ID) that will carry the content packages. The web content server 5 may combine the scheduled broadcast time and flow ID information with the descriptive information regarding the webpage content elements (e.g., webpage name or ID, object ID, etc.) to generate content packet descriptions (CPDs) for transmission via an overhead flow. Such content packet descriptions may be in the form of a catalogue listing of web content elements, which may be transmitted like other content catalogs carried by the broadcast network. The web content server 5 may provide the assembled webpage content element packages to the content broadcast system 4 via an internal network dataflow 22, along with the content packet descriptions via an internal network dataflow 24. The data packages may be stored until the appropriate broadcast time, at which point the content broadcast system 4 encodes the appropriate packages into a multiplex broadcast waveform which is broadcast via the network transmitters 2 as broadcast transmissions of webpage content element packages 26, and content description flows 28 which includes the content package descriptions for the webpage content elements.

A typical mobile multimedia broadcast network transmits content on a plurality of different channels or flows, thereby enabling several different programs to be broadcast simultaneously. Due to the nature of the broadcast transmission waveform, the plurality of different channels or flows may be carried over the same radio frequency spectrum, but include a structure and information that enables each of the channels or flows to be selected and received by the mobile devices 10. Individual channels or flows may be identified by an address or a flow identifier (ID). Information within the content description flow enables mobile devices 10 to determine the particular address in order to receive particular content.

Mobile devices 10 receive the broadcast transmissions and are able to separately process the broadcast web page content element transmissions 26 and the content description packet transmissions 28. Specifically, mobile devices 10 monitor the broadcast overhead flows to receive broadcast catalogs and content packet descriptions as part of determining the portion of the broadcast signal to be received. By monitoring the content package description flow, receiver devices 10 are able to identify those webpage content elements that are of interest to a user (e.g., having an ID matching webpages or webpage services to which the user has subscribed) and activate a receiver at the designated broadcast time to access the designated flow ID in order to receive the web page content elements.

In order to enable mobile devices 10 to receive broadcast webpage content elements, the content package descriptions for the webpage content elements may be broadcast in advance in a manner similar to how other content catalogs are broadcast. The timing relationship between content package description broadcasts on the content description flow and the corresponding webpage content element package broadcasts on the content flow is illustrated in FIG. 6. As illustrated in FIG. 6, the content package description packets 50 are broadcast on the content description flow of the broadcast signal before the corresponding webpage content elements packages 40 are broadcast on the content flow of the broadcast signal. A content package description 50 may include information regarding the start time, broadcast address or flow ID, identity of the webpage content elements (e.g., webpage identifier and object ID), and other information that enables the mobile device to identify and receive selected content when it is broadcast. This timing enables a receiver device 10 to receive the content description messages, and review the information regarding the webpage content element packages the broadcast (e.g., their identifier and object ID) to determine if any should be received, such as their webpage ID matches a subscribed website ID and the object ID does not match an object already stored in memory. If the receiver device 10 determines that one or more webpage content element packages should be received, the device can use the information within the content description messages to receive the identified content.

It should be noted that the webpage ID used by the transport layer to identify webpage content elements and used by the receiver devices to selectively received content of interest in most cases will be different from the webpage's normal Internet URL (in the case of an Internet website). For example, an element for a CNN news article might have as its identifier “/web/cnn/article_{—}10” instead of the URL for the article that would be used to access the webpage via the Internet. However, in some implementations the webpage URL may be used as the identifier or as part of the webpage identifier.

Broadcasting webpage content elements in preannounced broadcast windows enables receiver devices to conserve battery power, since they only need to activate their receiver circuitry when a required webpage content element is to be broadcast. Thus, the various embodiments enable a broadcast network to broadcast webpage content elements for a large number of websites without reducing the effective battery life of receiver devices since devices only received the broadcast content for which the user has expressed an interest, such as by subscribing to a particular website.

In order to efficiently communicate content description information in a reliable communication package, content package description messages may generated according to an information processing algorithm that condenses the content information and formats it into a broadcast format that can be received with low error rates even in a noisy environment.

The amount of web content that may be broadcast by a broadcast network implementing the various embodiments may be too great to be stored in memory of a typical mobile device. Thus, in a typical implementation, a mobile device may select a subset of the broadcast web content for reception and downloaded. Broadcast web content may be divided into one or more “web flows,” which refer to broadcasts of webpage content element packages related to a given website or series of websites. Content from each web content provider may be organized a web flow. For example, a News Central web flow (i.e., the web flow corresponding to content provided by the hypothetical website News Central) may comprise the broadcasts of webpage content element packages including a main page template or program which can display the latest headlines corresponding to news stories stored in the local data store, an article template or program for formatting and displaying a raw news story, standard graphics or banners for the website, and the various data updates that include the raw news stories and images. In some embodiments, users may select or subscribe to web flows they wish to access. Selecting or subscribing to a web flow informs their receiver device about the webpage content element packages to receive and store, namely the webpage content element packages associated with the selected or subscribed web flows. In a further embodiment, receiver devices may be configured to automatically subscribe to certain web flows based on any number of determine mobile parameters, such as customer demographics, user's browsing history, and/or marketing initiatives of the mobile broadcast network service provider. In some embodiments, a user may be able to subscribe to only a portion of a web flow. Returning to the News Central example, a user might wish to subscribe to only top news stories, top sports stories, stories containing the word “Qualcomm,” and/or editorials from a certain writer. So configured, a receiver device would only receive those webpage content element packages with webpage IDs and object IDs (or other filtering criteria) that match the webpage IDs and object IDs associated with the subscribed to portions.

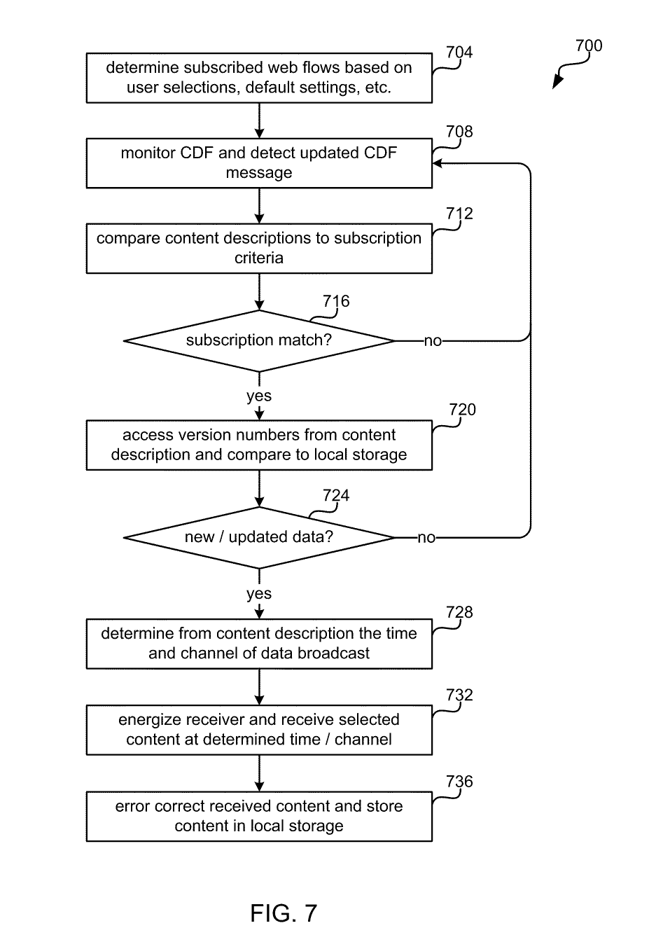

A method 700 for determining which broadcast web content to receive is shown in FIG. 7, which shows process steps that may be implemented in a mobile device. Method 700 for receiving broadcast web content includes operations that may be implemented as part of the receiver and store content step 402 of method 400 described above with reference to FIG. 4. In method 700 at step 704, the mobile device may determine the selected or subscribed websites or web flows or portions thereof that have been selected or subscribe to based on user selections or up other criteria. The mobile device may monitor the content description flow (i.e., the overhead flow carrying a listing and description of the webpage content element package broadcasts) and detect when an updated content description message is received in step 708. The mobile device may compare the webpage content element package descriptions in the updated content description message to the local subscription criteria in step 712. The local subscription criteria may include the webpage identifiers of selected websites, a web flow name or identifier, or other information useful for selecting webpage content element packages for reception. The mobile device may determine if the webpage content element package descriptions match one or more local subscription criteria in determination step 716. If the webpage content element package descriptions do not match a local subscription criterion (i.e., determination step 716=“no”), the mobile device may await the next update of the content description flow by returning to step 708. If the content descriptions do match a local subscription criterion (i.e., step 716=“yes”), such as may be the case when the webpage content element to this for a website to which the user has subscribed, the mobile device may determine whether the webpage content element package should be received.

In some embodiments, a content description may indicate a plurality of broadcast times and flow IDs when broadcasters broadcast the same content multiple times to provide redundancy in the event that the mobile device cannot receive a broadcast (e.g., due to lack of battery power or signal power). By comparing the information regarding broadcast webpage content element packages included in the content description flow to the webpage content elements stored in memory, mobile devices can avoid the unnecessary power drain from downloading redundant copies of content elements. Therefore, if the content descriptions match a local subscription criterion, the mobile device may access a version number of the matching content description within the content description and compare it to a version number of the same or similar content stored in memory in step 720. Based upon this comparison, the mobile device may determine whether the matching content description corresponds to a webpage content element that has not already been received in determination step 724. If the information in the content description enables the receiver device to determine that the webpage content element package is already stored in memory (i.e., determination step 724=“no”), the mobile device may await the next update of the content description flow by returning to step 708.

If the information in the content description enables the receiver device to determine that the webpage content element package is not stored in memory, and therefore should be received, (i.e., determination step 724=“yes”), the mobile device may determine from the content description the time and channel of the matching webpage content element package broadcast in step 728. The mobile device may store the broadcast time and channel information in a command queue that allows the mobile device to energize the broadcast receiver at the appointed time to receive the selected content in step 732. Received webpage content element packages may be decoded, error corrected and stored in the local data storage in step 736.

The various steps in the method 700 may occur asynchronously or in different order than shown in FIG. 7. For example, the mobile device may receive and process several content description messages before receiving broadcast webpage content element packages. Further, the mobile device may determine selected websites or subscribed web flows (i.e., step 704) only one time or only occasionally. For example, the mobile device may process automatic subscription criteria once per day to determine whether to add or remove selection criteria associated with subscribed web flows.

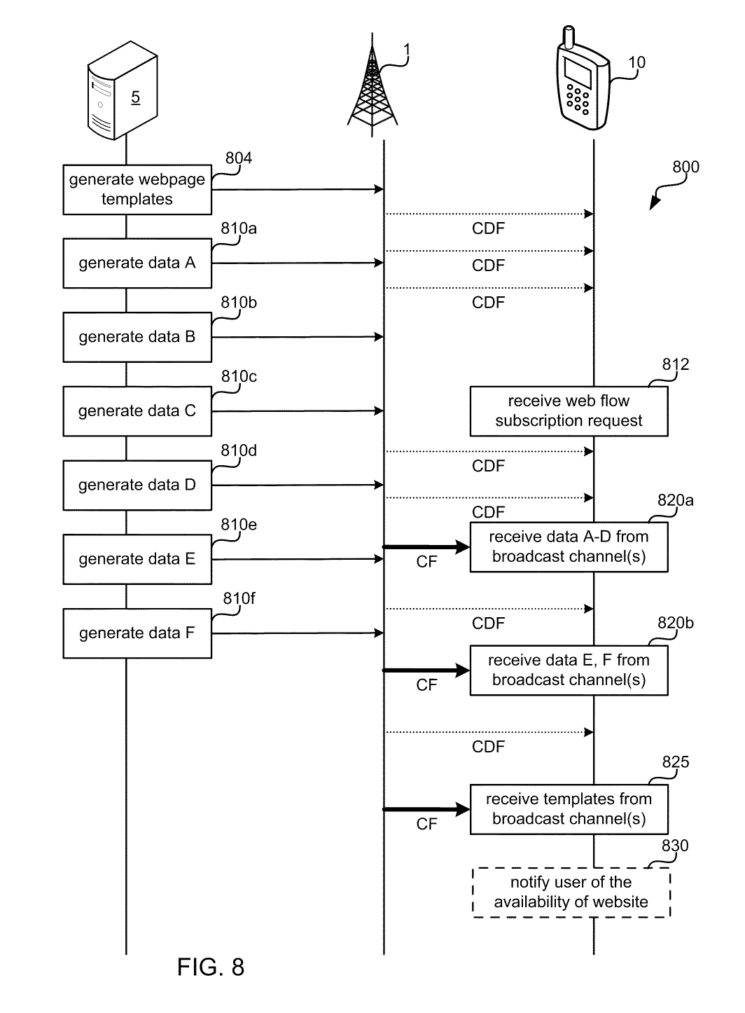

In a typical embodiment, the template or program portions of the web content may be broadcast periodically, regardless of whether they have been recently updated. Example message flows 800 of transmissions that may be implemented for broadcasting webpage content elements is illustrated in FIG. 8, which shows process steps that may be implemented in a computing device along with communication messages. A web content provider server 5 may generate mobile web page templates or programs, step 804, and generate web content elements that are assembled into webpage content element packages, steps 810a-f. The web content provider may send these webpage content element packages to the mobile broadcast network 1 at any time (e.g., periodically in the form of updates). The mobile broadcast network 1 may periodically broadcast descriptions of the webpage content element packages in a content description flow (CDF) that are broadcast before the individual webpage content element packages. The mobile devices may receive a request to subscribe to a web flow, step 815. In response, mobile device may monitor the content description flows and receive all webpage content element packages corresponding to a subscribed web flow, steps 820a-b. However, the mobile device may have to wait to receive the appropriate templates or programs, step 825, before it can present the data to the user. Once the mobile device has received all of the templates/programs and webpage content element package for a subscribed web flow or selected website, it may notify the user that the selected website is available for browsing, optional step 830.

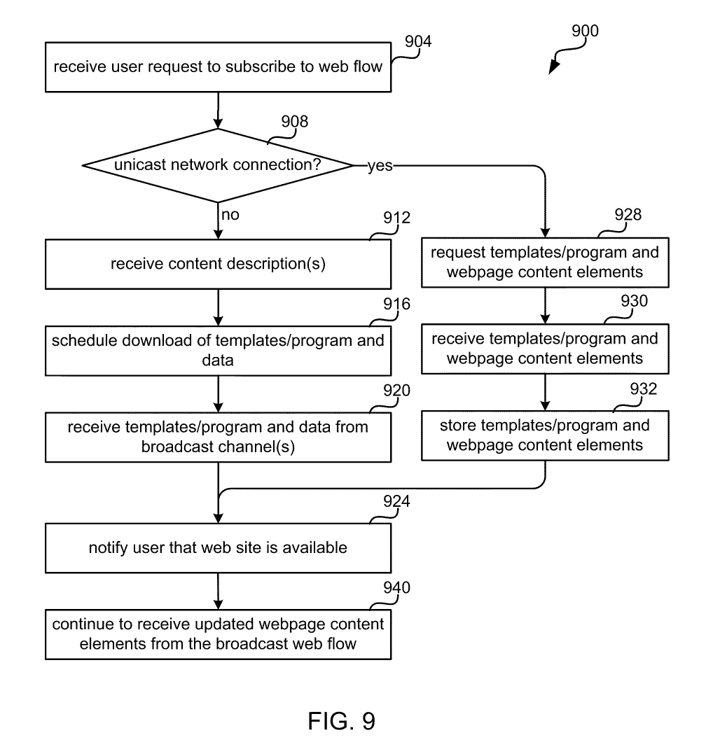

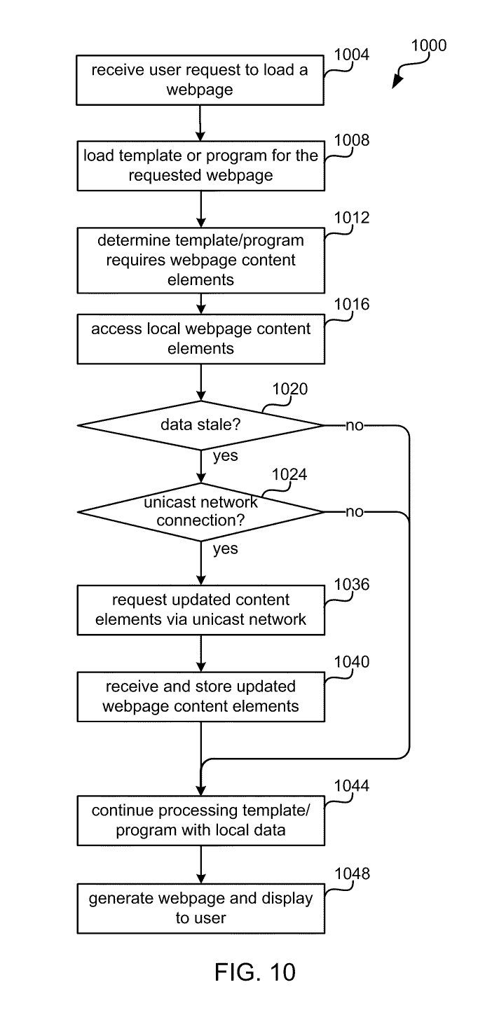

In some embodiments, the mobile device may be configured to both receive transmissions from a mobile multimedia broadcast network and communicate via a unicast network (e.g., a 3G data network). The broadcast web environment enabled by the various embodiments may complement a unicast data network by providing a faster and more bandwidth-efficient web browsing experience for commonly accessed websites, while the unicast network enables users to subscribe to particular broadcast web flows or websites as well as access websites that are not supported by the broadcast network. For example, a mobile device configured to access the Internet via a unicast network may download the templates/programs and webpage content elements using the unicast network the first time a website or web flow is selected by a user in order to quickly make the site available for browsing. Example methods suitable for use with a unicast network are illustrated in FIGS. 9 and 10.

An embodiment method 900 for receiving templates/programs and webpage content elements for a newly subscribed to web flow via a unicast network is illustrated in FIG. 9, which shows process steps that may be implemented on a receiver device. In method 900 at step 904, the mobile device may receive a user request to subscribe to a web flow. The mobile device may determine whether a unicast network connection is available, determination step 908. If so (i.e., determination step 908=“yes”), the mobile device may transmit an HTTP request to the appropriate server over the unicast network connection (e.g., via an Internet enabled 3G link) requesting transmission of templates/programs and webpage content elements associated with the subscribed web flow, step 928. This HTTP request may be directed to the Web server of the broadcast network which may maintain the templates/programs and webpage content elements in memory for broadcast and for responding to such requests for mobile devices. With a unicast network connection established, the mobile device may receive the requested templates/programs and webpage content elements in step 930, and store them in the local memory of the mobile device in step 932. Once the requested webpage content elements have been received via the unicast network and stored in memory where they may be accessed by the web server application, the mobile device may notify the user that the website is available for browsing in step 924. Thereafter, the mobile device may continue to receive updated webpage content elements from the broadcast web flow in step 940 by implementing processes similar to those described above with reference to FIG. 7.

While FIG. 9 and the foregoing description address a case where the webpage content elements and templates/programs are broadcast in a web flow by the broadcast network, similar processes may be used in situations where the broadcast network does not implement web flows or the requested website is not hosted in a web flow. In such a case, the user request received in step 904 may be to monitor or subscribed to a particular website, and the request for templates/programs and webpage content elements in step 928 may be directed to the remote server supporting the selected website, such as by accessing the URL for the server supporting the selected website via the unicast network and the Internet.

If the mobile device determines that it does not have a unicast network connection (i.e., determination step 908=“no”), the mobile device may obtain the necessary template/program and webpage content elements from the broadcast web flows by performing operations similar to those described above with reference to FIG. 7. Specifically, the mobile device may monitor the content description flows to determine when templates/programs and webpage content elements associated with the selected web flow will be broadcast, step 912, schedule the download of templates/programs and webpage content elements, step 916, and receive the templates/programs and webpage content elements when they are broadcast, step 920. Once the requested webpage content elements have been received via the broadcast web flow transmissions, the mobile device may notify the user that the website is available for browsing in step 924. Thereafter, the mobile device may continue to receive updated webpage content elements from the broadcast web flow in step 940 by implementing processes similar to those described above with reference to FIG. 7.

In some implementations, webpage data or files may be considered stale if updated data has not been received within a predefined number of hours. The threshold for stale data may be determined by user preferences, mobile network operator preferences, and/or content provider preferences, such as may be indicated in the webpage template or program. Webpage data may become stale if the user turns off the mobile device for a period of time such that it is unable to download periodic updates as described above with reference to FIG. 7. If the user turns on the mobile device after an extended shutdown period, the data and files for a requested webpage may have an age (i.e., a duration since the last update) that exceeds a normal refresh or update duration. To address this concern, receiver devices may be configured to implement embodiment method 1000 illustrated in FIG. 10 for updating aged webpage content elements when the receiver device is also configured to access a unicast network.

In method 1000 in step 1004, the mobile device may receive a user request to load a webpage. The mobile device may load a default template or program for that webpage from local memory in step 1008. The mobile device may determine from the webpage template or program any data or files that are required to generate the requested webpage (e.g., the most recent top news headlines) in step 1012. The mobile device may access the local memory to obtain the required data or files in step 1016. In determination step 1020, the mobile device may determine whether any of the obtained data or files is stale (i.e., whether the data is older than a threshold value that may be specified in the template or program). The mobile device may determine the age of the data or file by comparing a date and time of value associated with the webpage data or file to a current time. If the mobile device determines that an obtained data or file is stale (i.e., determination step 1020=“yes”), the mobile device may determine whether there is a unicast network connection available in determination step 1024. If the mobile device can access a unicast network (i.e., determination step 1024=“yes”), the mobile device may access the unicast network and transmit an HTTP message via the unicast network to an appropriate server requesting updated webpage content elements in step 1036. If the webpage content elements for the requested website or webpage are broadcast as part of a web flow, the mobile device may direct the HTTP request message to the web content server of the broadcast network requesting updated webpage content elements associated with the corresponding web flow. The address of the web content server may have been stored in memory as part of the procedure of subscribing to the particular web flow. If the webpage content elements for the requested website or webpage are not broadcast as part of a web flow, the mobile device may direct the HTTP request message to the URL of the of the remote server supporting the website or webpage. In step 1040, the mobile device may receive the updated webpage content elements via the unicast network connection. The mobile device may continue processing the template/program in step 1044 to generate the webpage, and display it to the user in step 1048. If the webpage data or files are either not stale (i.e., determination step 1020=“no”) or there is no available unicast network connection (i.e., determination step 1024=“no”), the mobile device may continue processing the template/program using the locally obtained data and files (i.e., stale data) by proceeding directly to step 1044, and generate the webpage and display it to the user in step 1048.

In a further aspect, the local web server may be configured to use both the broadcast and unicast communication networks to provide websites to users while leveraging the efficient transmission capabilities of the broadcast network. In this aspect, webpage elements for subscribed websites may be downloaded regularly as described above. When a user asks to access a particular website the local web server may contact a remote server supporting that website via the unicast network to obtain an up to the minute listing of webpages associated with the site and present the listing to the user. When a user selects a particular page for viewing, the local web server generates the requested webpage using webpage elements stored in memory, if available, and if not in memory (i.e., the webpage elements have not yet been received via the broadcast network), the local web server obtains the required webpage elements via the unicast network and then generates the webpage. Thus, in this aspect, the local web server determines whether the webpage elements for the requested webpage are available in memory, and if not, the local web server obtains them via the unicast network (if available).

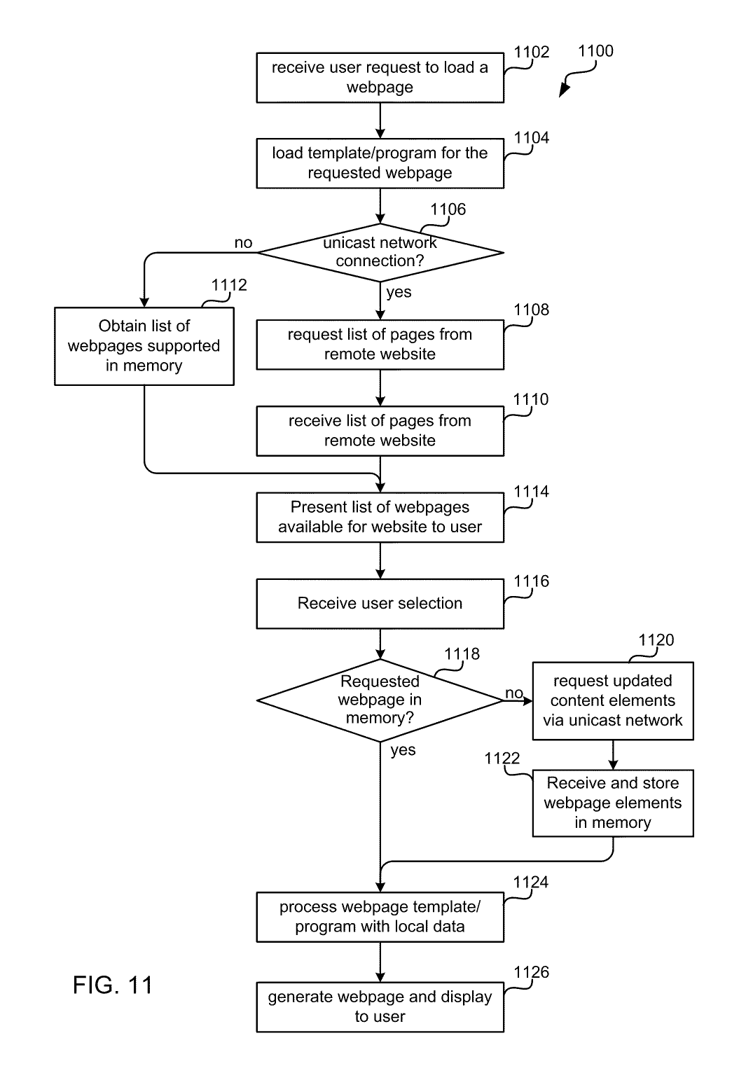

This aspect is illustrated in FIG. 11 which illustrates a method 1100 which may be implemented in a receiver device. In method 1100 in block 1102 a receiver device may receive a user input requesting the display of a webpage. Such a request may be in any form typically available with web browsers, such as in the form of entry of a website name (e.g., “CNN” or “cnbc.com”), selection of a hyperlink, or selection of a “favorites” link within the web browser interface display. In block 1104, web browser may forward the request to the local web server executing on the processor of the receiver device which may load the template or program corresponding to the requested webpage (if it is not already loaded). In determination block 1106, the local web server may determine if there is access to a unicast network (e.g., whether a unicast communication link is available or whether a unicast connection can be established). If a unicast network connection is available (i.e., determination block 1106=“yes”), the local web server may send a request (e.g., via a HTTP message) to a remote web server supporting the requested website via the unicast network requesting a list of webpages currently associated with or available on the website in block 1108. In some aspects, the request for a list of webpages sent to the remote website may include a list of the webpages currently stored in memory (e.g., may be generated by the local web server accessing the memory) to enable the remote web server to generate a list of missing webpages. In other aspects the request may be for a list of all webpages associated with the website. Upon receiving this request the remote web server may transmit a reply that includes the requested list of pages associated with the website that the receiver device local web server receives in block 1110. If a unicast network connection is not available (i.e., determination block 1112=“no”), the local web server may access local memory to obtain or generate a list of the website webpages that can be generated based upon webpage elements stored in memory. As discussed above such webpage elements will have been downloaded from the broadcast network in the preceding hours and days.

In block 1114 the web server provides the list (obtained either from memory in block 1112 or received from the remote server in block 1110) of available webpages for the requested website to the web browser for display to the user. In block 1116 the web browser may receive a user input in the form of selection of one of the listed webpages. The web browser may pass the user selection information (e.g., in the form of a URL access request) to the local web server. In determination block 1118 the local web server may determine whether the webpage elements necessary to generate the selected webpage are stored in memory. If the selected webpage elements are not stored in memory (i.e., determination step 1118=“no”), the local web server may use the unicast network to access the remote server supporting the requested website and send an HTTP (or similar) request message requesting the updated webpage content elements for the selected webpage in block 1120. In block 1122, the local web server may receive the requested webpage elements and store them in memory.

If the requested webpage is supported by webpage elements stored in memory (i.e., determination step 1118=“yes”) or after receiving requested webpage elements in block 1122, the local web server may process the template or program for the requested webpage using the webpage elements stored in memory in block 1124. In block 1126 the local web server generates the requested webpage and passes the generated web page to the web browser for display to the user.

In a typical implementation of this aspect, a user may enter a command (e.g., select a browser hyperlink to a webpage) or type in a website name (e.g., “CNN” or “cnn.com”) to access a particular website, such as a news site hosted by the local web server which may have a local URL different from the URL of the website typically accessed on the Internet (e.g., http://localhost:8080/com). The template or program in charge of the news site on the local web server may send a list of news articles it currently has stored in memory to the remote web server via the unicast to a web address that may be embedded in the program. The remote web server may compare the received list against a current status of the new site to check if there are any news article webpage elements missing from the receiver device's list. If so, the remote server may transmit back a response message via the unicast network providing a list of news articles that are missing from the local list (i.e., the list of article webpage elements stored in memory). The local web server may then present the list of article webpage elements (e.g., CNN news articles) to the user. For example, the list may include webpage IDs or titles for article webpage elements that are not currently on the local web server. If the user clicks one of the missing webpage names or titles, the local web server may access the unicast network to download the corresponding content elements from the remote server, generate the web page from the received webpage elements and present the webpage to the user. In various aspects the URL used to access the element is a “local” URL (e.g., http://localhost:8080/cnn/article_{—}10), and not a remote URL (e.g., http://cnn.com/article_{—}10). In this manner a user may have the flexibility to select the remote web page directly. In the special case of the web server acting as a web proxy, the URL may be a remote URL.

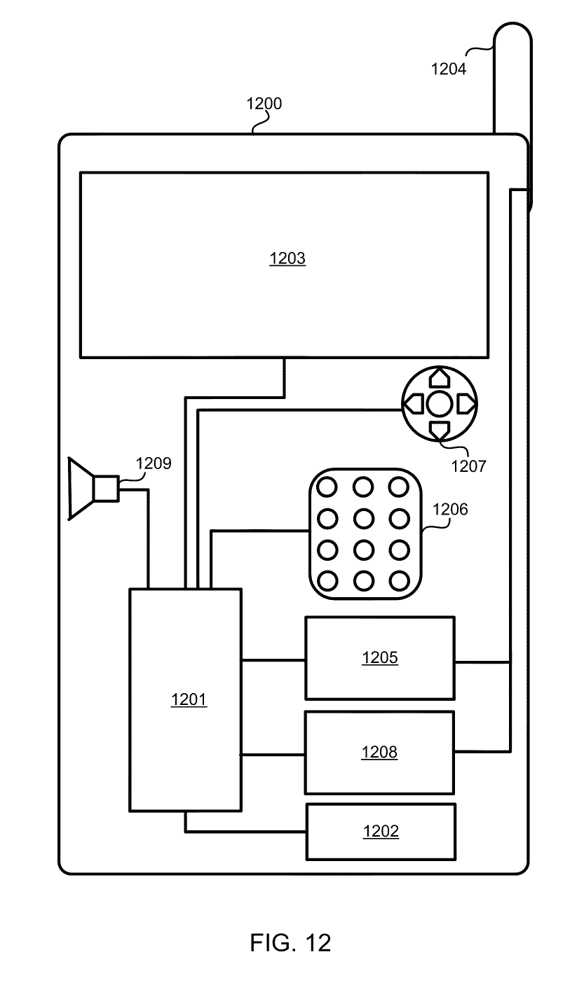

FIG. 12 is a system block diagram of a receiver device suitable for use with any of the embodiments. A typical receiver device 1200 may include a processor 1201 coupled to internal memory 1202, a display 1203, and to a speaker 1209. Additionally, the receiver device 1200 may include an antenna 1204 for sending and receiving electromagnetic radiation that may be connected to a wireless data link and/or cellular telephone transceiver 1205 coupled to the processor 1201 and a mobile multimedia broadcast receiver 1208 coupled to the processor 1201. Receiver devices 1200 may also include menu selection buttons 1206 or rocker switches 1207 for receiving user inputs.

The various embodiment methods for receiving and processing interactivity event signaling messages may be performed by the multimedia broadcast receiver 1208 and portions of the processor 1201 and memory 1202. Alternatively, dedicated modules within or coupled to the multimedia broadcast receiver 1208 may perform the embodiment methods.

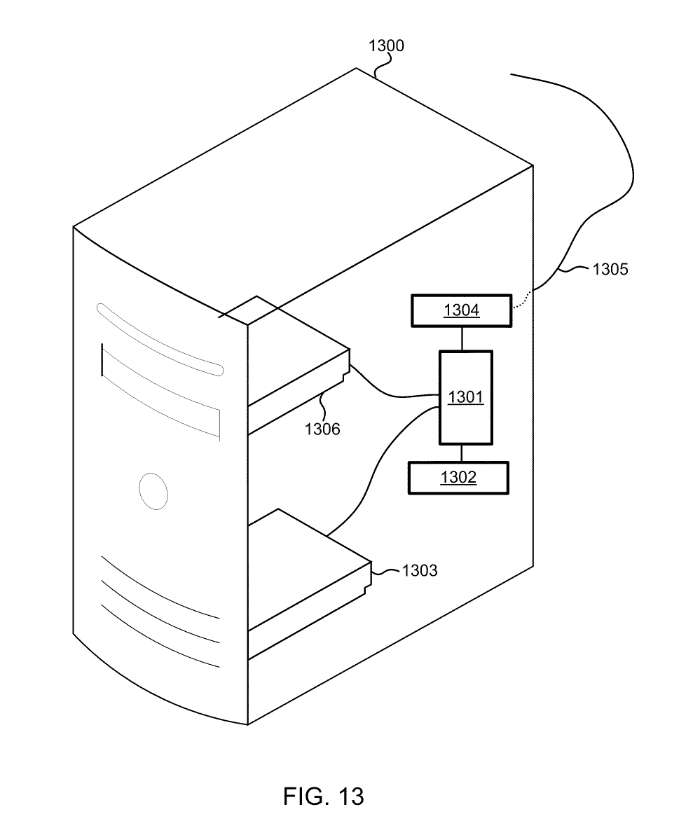

The various embodiments on the broadcast side described above may be implemented on any of a variety of commercially available server devices, such as the server 1300 illustrated in FIG. 13. Such a server 1300 typically includes a processor 1301 coupled to volatile memory 1302 and a large capacity nonvolatile memory, such as a disk drive 1303. The server 1300 may also include a floppy disc drive, compact disc (CD) or DVD disc drive 1306 coupled to the processor 1301. The server 1300 may also include network access ports 1304 coupled to the processor 1301 for establishing data connections with a network 1305, such as a local area network coupled to other broadcast system computers and servers.

The processors 1201, 1301 may be any programmable microprocessor, microcomputer or multiple processor chip or chips that can be configured by software instructions (applications) to perform a variety of functions, including the functions of the various embodiments described below. In some mobile receiver devices, multiple processors 1301 may be provided, such as one processor dedicated to wireless communication functions and one processor dedicated to running other applications. Typically, software applications may be stored in the internal memory 1202, 1302, 1303 before they are accessed and loaded into the processor 1201, 1301. The processor 1201, 1301 may include internal memory sufficient to store the application software instructions.

As discussed above, the various embodiments may be used for delivering a variety of rich media content, and not just Internet web content. Accordingly, the scope of the claims should not be limited to Internet web content delivery and reception unless specifically recited.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium. The steps of a method or algorithm disclosed herein may be embodied in a processor-executable software module executed which may reside on a tangible or non-transitory computer-readable storage medium. Non-transitory computer-readable storage media may be any available storage media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also can be included within the scope of non-transitory computer-readable media. Additionally, the operations of a method or algorithm may reside as one or any combination or set of codes and/or instructions on a non-transitory machine readable medium and/or non-transitory computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for broadcasting content in a mobile multimedia broadcast system, comprising:
assembling a content element into a content element package suitable for broadcast via a broadcast network;
broadcasting a content description message describing the content element and identifying a time at which the content element package will be broadcast; and
broadcasting the content element package at the identified time.

2. The method of claim 1, wherein the content element is a webpage content element, and the content element package is a webpage content element package.

3. A method of accessing rich media content in a receiver device configured to receive transmissions from a broadcast network, comprising:
receiving in the receiver device a broadcast content description message describing a content element and identifying a time at which a package including the content element will be broadcast;
determining in the receiver device from at least some of the information included in the received content description message whether the package including the content element should be received;
receiving the package including the content element at the identified broadcast time when it is determined that the content element should be received;
storing the received content in memory of the receiver device;
receiving a request to access the content in the receiver device; and
rendering the requested content using an application resident in the receiver device.

4. The method of claim 3, wherein:
the content element is a webpage content element;
the content element package is a webpage content element package;
receiving a request to access the content in the receiver device comprises receiving a request to access a webpage in the receiver device; and
rendering the requested content using an application resident in the receiver device comprises:
generating the requested webpage in a web server application operating in the receiver device using the stored webpage content element; and
providing the generated requested webpage to a web browser operating in the receiver device.

5. The method of claim 4, wherein generating the requested webpage comprises:
obtaining a template for the requested webpage from memory in the receiver device; and
applying in the receiver device the obtained template to the stored webpage content element.

6. The method of claim 5, further comprising receiving the template for the requested webpage from the broadcast network and storing the received template in memory in the receiver device.

7. The method of claim 4, wherein generating the requested webpage comprises:
loading from memory in the receiver device a program for execution on the web server of the receiver device, the program configured to generate the requested webpage according to logic implemented in the program; and
processing the stored webpage content element in the program.

8. The method of claim 7, further comprising receiving the program for the requested webpage from the broadcast network and storing the received program in memory in the receiver device.

9. The method of claim 4, wherein determining whether the package including the webpage content element should be received is based at least in part upon an identifier associated with the webpage content element.

10. The method of claim 9, further comprising:
receiving a user request to access a website; and
using an identifier of the requested website as the identifier associated with the webpage content element for determining whether the package including the webpage content element should be received.

11. The method of claim 10, wherein the identifier associated with the webpage content element is not an Internet URL for the requested website.

12. The method of claim 9, further comprising:
receiving a user request to access a web flow of the broadcast network broadcasting content of the requested website; and
using an identifier of the requested web flow as the identifier associated with the webpage content element for determining whether the package including the webpage content element should be received.

13. The method of claim 9, further comprising:
determining in the receiver device from at least some of the information included in the received content description message a version of the webpage content element that will be broadcast; and
comparing the version of the webpage content element that will be broadcast to a version of a webpage content element stored in memory of the receiver device,
wherein determining whether the package including the webpage content element should be received is based at least in part upon whether the version of the webpage content element that will be broadcast is newer than the version of the webpage content element stored in memory of the receiver device.

14. The method of claim 9, wherein the webpage content element includes an address for accessing the requested website via a network which may be different from the identifier of the requested web flow, the method further comprising:
determining whether a unicast network connection is available to the receiver device;
accessing a remote server supporting the requested website via the unicast network connection when it is determined that a unicast network connection is available to the receiver device;
requesting a download of webpage content elements; and
storing webpage content elements received from the remote server via the unicast network connection.

15. The method of claim 14, further comprising:
requesting from the remote server supporting the requested website a list of webpages available at the requested website when it is determined that a unicast network connection is available to the receiver device;
generating and displaying in the receiver device a list of webpages corresponding to the requested website;
receiving a user input selecting one of the listed webpages; and
determining whether the selected one of the listed webpages is supported by webpage elements stored in memory of the receiver device,
wherein requesting a download of webpage content elements is accomplished when it is determined that the selected one of the listed webpages is supported by webpage elements stored in memory of the receiver device.

16. The method of claim 15, wherein requesting from the remote server supporting the requested website a list of webpages available at the requested website comprises:
transmitting to the remote server supporting the requested website a list of webpages supported by webpage elements stored in memory of the receiver device; and
receiving from the remote server via the unicast network a list of missing webpages which are available at the remote server but not included in the list of webpages supported by webpage elements stored in memory of the receiver device,
wherein generating and displaying in the receiver device a list of webpages corresponding to the requested website comprises generating the list of webpages corresponding to the requested website based on a combination of the list of webpages supported by webpage elements stored in memory of the receiver device and the list of missing received webpages.

17. The method of claim 12, wherein the identifier associated with the webpage content element comprises a web flow identifier.

18. The method of claim 17, further comprising:
determining whether a unicast network connection is available to the receiver device;
accessing a web content server of the broadcast network via the unicast network connection when it is determined that a unicast network connection is available to the receiver device;
requesting a download of webpage content elements associated with the requested web flow from the web content server; and
storing webpage content elements received from the web content server via the unicast network connection.

19. The method of claim 7, wherein the program for the requested webpage includes an address of a remote server which may be contacted via a network, wherein the address of the remote server is different from the web flow identifier.

20. The method of claim 4, further comprising:
determining whether an age of the stored webpage content element exceeds a threshold value prior to generating the requested webpage;
determining whether a unicast network connection is available to the receiver device when it is determined that the age of the stored webpage content exceeds the threshold value;
accessing the requested website via the unicast network connection when it is determined that a unicast network connection is available to the receiver device;
downloading an updated webpage content element from the requested website via the unicast network connection; and
storing the updated webpage content element in the memory of the receiver device,
wherein generating the requested webpage in the web server application operating in the receiver device using the stored webpage content element uses a most recently stored webpage content element.

21. A wireless communication system, comprising:
a wireless broadcast network;
a wireless unicast communication network; and
a receiver device configured to receive transmissions from the broadcast network and communicate via the wireless unicast communication network,
wherein the wireless broadcast network comprises a server coupled to a transmitter system, wherein the server is configured with server executable instructions to perform operations comprising:
assembling a content element into a content element package suitable for broadcast via a broadcast network;
broadcasting a content description message describing the content element and identifying a time at which the content element package will be broadcast; and
broadcasting the content element package at the identified time, and
wherein the receiver device comprises:
a processor;
a broadcast receiver circuit coupled to the processor and configured to receive broadcast transmissions from a broadcast network; and
a memory coupled to the processor,
wherein the receiver device processor is configured with processor-executable instructions to perform operations comprising:
receiving in the receiver device a broadcast content description message describing a content element and identifying a time at which a package including the content element will be broadcast;
determining in the receiver device from at least some of the information included in the received content description message whether the package including the content element should be received;
receiving the package including the content element at the identified broadcast time when it is determined that the content element should be received;
storing the received content in memory of the receiver device;
receiving a request to access the content in the receiver device; and
rendering the requested content using an application resident in the receiver device.

22. The wireless communication system of claim 21, wherein the content element is a webpage content element, and the content element package is a webpage content element package.

23. The wireless communication system of claim 22, wherein the receiver device processor is configured with processor-executable instructions to perform operations such that:
receiving a request to access the content in the receiver device comprises receiving a request to access a webpage in the receiver device; and
rendering the requested content using an application resident in the receiver device comprises:
generating the requested webpage in a web server application operating in the receiver device using the stored webpage content element; and
providing the generated requested webpage to a web browser operating in the receiver device.

24. The wireless communication system of claim 23, wherein the receiver device processor is configured with processor-executable instructions to perform operations such that generating the requested webpage comprises:
obtaining a template for the requested webpage from memory in the receiver device; and
applying in the receiver device to the obtained template to the stored webpage content element.

25. The wireless communication system of claim 24, wherein the receiver device processor is configured with processor-executable instructions to perform operations further comprising receiving the template for the requested webpage from the broadcast network and storing the received template in memory in the receiver device.

26. The wireless communication system of claim 23, wherein the receiver device processor is configured with processor-executable instructions to perform operations such that generating the requested webpage comprises:
loading from memory in the receiver device a program for execution on the web server of the receiver device, the program configured to generate the requested webpage according to logic implemented in the program; and
processing the stored webpage content element in the program.

27. The wireless communication system of claim 26, wherein the receiver device processor is configured with processor-executable instructions to perform operations further comprising receiving the program for the requested webpage from the broadcast network and storing the received template in memory in the receiver device.

28. The wireless communication system of claim 23, wherein the receiver device processor is configured with processor-executable instructions to perform operations such that determining whether the package including the webpage content element should be received is based at least in part upon an identifier associated with the webpage content element.

29. The wireless communication system of claim 28, wherein the receiver device processor is configured with processor-executable instructions to perform operations further comprising:
receiving a user request to access a website; and
using an identifier of the requested website as the identifier associated with the webpage content element for determining whether the package including the webpage content element should be received.

30. The wireless communication system of claim 29, wherein the identifier associated with the webpage content element is not an Internet URL for the requested website.

31. The wireless communication system of claim 28, wherein the receiver device processor is configured with processor-executable instructions to perform operations further comprising:
receiving a user request to access a web flow of the broadcast network broadcasting content of the requested website; and
using an identifier of the requested web flow as the identifier associated with the webpage content element for determining whether the package including the webpage content element should be received.

32. The wireless communication system of claim 28, wherein the receiver device processor is configured with processor-executable instructions to perform operations further comprising:
determining in the receiver device from at least some of the information included in the received content description message a version of the webpage content element that will be broadcast; and
comparing the version of the webpage content element that will be broadcast to a version of a webpage content element stored in memory of the receiver device,
wherein determining whether the package including the webpage content element should be received is based at least in part upon whether the version of the webpage content element that will be broadcast is newer than the version of the webpage content element stored in memory of the receiver device.

33. The wireless communication system of claim 28, wherein the receiver device processor is configured with processor-executable instructions to perform operations such that the webpage content element includes an address for accessing the requested website via a network which may be different from the identifier of the requested web flow, and wherein the receiver device processor is configured with processor-executable to perform operations further comprising:
determining whether a unicast network connection is available to the receiver device;
accessing a remote server supporting the requested website via the unicast network connection when it is determined that a unicast network connection is available to the receiver device;
requesting a download of webpage content elements; and
storing webpage content elements received from the requested website via the unicast network connection.

34. The wireless communication system of claim 33, wherein the receiver device processor is configured with processor-executable instructions to perform operations further comprising:
requesting from the remote server supporting the requested website a list of webpages available at the requested website when it is determined that a unicast network connection is available to the receiver device;
generating and displaying in the receiver device a list of webpages corresponding to the requested website;
receiving a user input selecting one of the listed webpages; and
determining whether the selected one of the listed webpages is supported by webpage elements stored in memory of the receiver device,
wherein the receiver device processor is configured with processor-executable to perform operations such that requesting a download of webpage content elements is accomplished when it is determined that the selected one of the listed webpages is supported by webpage elements stored in memory of the receiver device.

35. The wireless communication system of claim 34, wherein the receiver device processor is configured with processor-executable instructions to perform operations such that requesting from the remote server supporting the requested website a list of webpages available at the requested website comprises:
transmitting to the remote server supporting the requested website a list of webpages supported by webpage elements stored in memory of the receiver device; and
receiving from the remote server via the unicast network a list of missing webpages which are available at the requested website but not included in the list of webpages supported by webpage elements stored in memory of the receiver device,
wherein generating and displaying in the receiver device a list of webpages corresponding to the requested website comprises generating the list of webpages corresponding to the requested website based on a combination of the list of webpages supported by webpage elements stored in memory of the receiver device and the list of missing received webpages.

36. The wireless communication system of claim 31, wherein the identifier associated with the webpage content element comprises a web flow identifier.

37. The wireless communication system of claim 36, wherein the receiver device processor is configured with processor-executable instructions to perform operations further comprising:
determining whether a unicast network connection is available to the receiver device;
accessing a web content server of the broadcast network via the unicast network connection when it is determined that a unicast network connection is available to the receiver device;
requesting a download of webpage content elements associated with the requested web flow from the web content server; and
storing webpage content elements received from the web content server via the unicast network connection.

38. The wireless communication system of claim 26, wherein the program for the requested webpage includes an address of a remote server which may be contacted via a network, wherein the address of a remote server is different from the web flow identifier.

39. The wireless communication system of claim 23, wherein the receiver device processor is configured with processor-executable instructions to perform operations further comprising:
determining whether an age of the stored webpage content element exceeds a threshold value prior to generating the requested webpage;
determining whether a unicast network connection is available to the receiver device when it is determined that the age of the stored webpage content exceeds the threshold value;
accessing the requested website via the unicast network connection when it is determined that a unicast network connection is available to the receiver device;
downloading an updated webpage content element from the requested website via the unicast network connection; and
storing the updated webpage content element in the memory of the receiver device,
wherein the receiver device processor is configured with processor-executable to perform operations such that generating the requested webpage in the web server application operating in the receiver device using the stored webpage content element uses a most recently stored webpage content element.

40. A multimedia broadcast network, comprising:
a broadcast transmission system; and
a server coupled to the broadcast transmission system,
wherein the server is configured with server-executable instructions to perform operations comprising:
assembling a content element into a content element package suitable for broadcast via a broadcast network;
generating a content description message describing the content element and identifying a time at which the content element package will be broadcast by the broadcast transmission system;
providing the generated content description message to the transmission system for broadcast; and
directing the broadcast transmission system to broadcast the content element package at the identified time.

41. The server of claim 40, wherein the content element is a webpage content element, and the content element package is a webpage content element package.

42. A multimedia broadcast network, comprising:
means for assembling a content element into a content element package suitable for broadcast via a broadcast network;
means for broadcasting a content description message describing the content element and identifying a time at which the content element package will be broadcast; and
means for broadcasting the content element package at the identified time.

43. A non-transitory computer readable storage medium having stored thereon server-executable instructions configured to cause a server of a multimedia broadcast network to perform operations comprising:
assembling a content element into a content element package suitable for broadcast via a broadcast network;
broadcasting a content description message describing the content element and identifying a time at which the content element package will be broadcast; and
broadcasting the content element package at the identified time.

44. A receiver device, comprising:
a processor;
a broadcast receiver circuit coupled to the processor and configured to receive broadcast transmissions from a broadcast network; and
a memory coupled to the processor,
wherein the processor is configured with processor-executable instructions to perform operations comprising:
receiving in the receiver device a broadcast content description message describing a content element and identifying a time at which a package including the content element will be broadcast;
determining in the receiver device from at least some of the information included in the received content description message whether the package including the content element should be received;
receiving the package including the content element at the identified broadcast time when it is determined that the content element should be received;
storing the received content in memory of the receiver device;
receiving a request to access the content in the receiver device; and
rendering the requested content using an application resident in the receiver device.

45. The receiver device of claim 42, wherein the processor is configured with processor-executable instructions to perform operations such that:
receiving a request to access the content in the receiver device comprises receiving a request to access a webpage in the receiver device; and
rendering the requested content using an application resident in the receiver device comprises:
generating the requested webpage in a web server application operating in the receiver device using the stored webpage content element; and
providing the generated requested webpage to a web browser operating in the receiver device.

46. The receiver device of claim 45, wherein the processor is configured with processor-executable instructions to perform operations such that generating the requested webpage comprises:
obtaining a template for the requested webpage from memory in the receiver device; and
applying in the receiver device to the obtained template to the stored webpage content element.

47. The receiver device of claim 46, wherein the processor is configured with processor-executable instructions to perform operations further comprising receiving the template for the requested webpage from the broadcast network and storing the received template in memory in the receiver device.

48. The receiver device of claim 45, wherein the processor is configured with processor-executable instructions to perform operations such that generating the requested webpage comprises:
loading from memory in the receiver device a program for execution on the web server of the receiver device, the program configured to generate the requested webpage according to logic implemented in the program; and
processing the stored webpage content element in the program.

49. The receiver device of claim 48, wherein the processor is configured with processor-executable instructions to perform operations further comprising receiving the program for the requested webpage from the broadcast network and storing the received template in memory in the receiver device.

50. The receiver device of claim 45, wherein the processor is configured with processor-executable instructions to perform operations such that determining whether the package including the webpage content element should be received is based at least in part upon an identifier associated with the webpage content element.

51. The receiver device of claim 50, wherein the processor is configured with processor-executable instructions to perform operations further comprising:
receiving a user request to access a website; and
using an identifier of the requested website as the identifier associated with the webpage content element for determining whether the package including the webpage content element should be received.

52. The receiver device of claim 51, wherein the identifier associated with the webpage content element is not an Internet URL for the requested website.

53. The receiver device of claim 50, wherein the processor is configured with processor-executable instructions to perform operations further comprising:
receiving a user request to access a web flow of the broadcast network broadcasting content of the requested website; and
using an identifier of the requested web flow as the identifier associated with the webpage content element for determining whether the package including the webpage content element should be received.

54. The receiver device of claim 50, wherein the processor is configured with processor-executable instructions to perform operations further comprising:
determining in the receiver device from at least some of the information included in the received content description message a version of the webpage content element that will be broadcast; and
comparing the version of the webpage content element that will be broadcast to a version of a webpage content element stored in memory of the receiver device,
wherein the processor is configured with processor-executable instructions to perform operations such that determining whether the package including the webpage content element should be received is based at least in part upon whether the version of the webpage content element that will be broadcast is newer than the version of the webpage content element stored in memory of the receiver device.

55. The receiver device of claim 50, further comprising a transceiver circuit coupled to the processor and configured to enable the processor to communicate with a wireless unicast network,
wherein the processor is configured with processor-executable instructions to perform operations such that the webpage content element includes an address for accessing the requested website via a network which may be different from the identifier of the requested web flow, and wherein the processor is configured with processor-executable instructions to perform operations further comprising:
determining whether a unicast network connection is available to the receiver device;
accessing a remote server supporting the requested website via the unicast network connection when it is determined that a unicast network connection is available to the receiver device;
requesting a download of webpage content elements; and
storing webpage content elements received from the requested website via the unicast network connection.

56. The receiver device of claim 55, wherein the processor is configured with processor-executable instructions to perform operations further comprising:
requesting from the remote server supporting the requested website a list of webpages available at the requested website when it is determined that a unicast network connection is available to the receiver device;
generating and displaying in the receiver device a list of webpages corresponding to the requested website;
receiving a user input selecting one of the listed webpages; and
determining whether the selected one of the listed webpages is supported by webpage elements stored in memory of the receiver device,
wherein the processor is configured with processor-executable instructions to perform operations such that requesting a download of webpage content elements is accomplished when it is determined that the selected one of the listed webpages is supported by webpage elements stored in memory of the receiver device.

57. The receiver device of claim 56, wherein the processor is configured with processor-executable instructions to perform operations such that requesting from the remote server supporting the requested website a list of webpages available at the requested website comprises:
transmitting to the remote server supporting the requested website a list of webpages supported by webpage elements stored in memory of the receiver device; and
receiving from the remote server via the unicast network a list of missing webpages which are available at the requested website but not included in the list of webpages supported by webpage elements stored in memory of the receiver device,
wherein the processor is configured with processor-executable instructions to perform operations such that generating and displaying in the receiver device a list of webpages corresponding to the requested website comprises generating the list of webpages corresponding to the requested website based on a combination of the list of webpages supported by webpage elements stored in memory of the receiver device and the list of missing received webpages.

58. The receiver device of claim 53, wherein the identifier associated with the webpage content element comprises a web flow identifier.

59. The receiver device of claim 58, further comprising a transceiver circuit coupled to the processor and configured to enable the processor to communicate with a wireless unicast network,
wherein the processor is configured with processor-executable instructions to perform operations further comprising:
determining whether a unicast network connection is available to the receiver device;
accessing a web content server of the broadcast network via the unicast network connection when it is determined that a unicast network connection is available to the receiver device;
requesting a download of webpage content elements associated with the requested web flow from the web content server; and
storing webpage content elements received from the web content server via the unicast network connection.

60. The receiver device of claim 48, wherein the program for the requested webpage includes an address of a remote server which may be contacted via a network, wherein the address of a remote server is different from the web flow identifier.

61. The receiver device of claim 45, further comprising a transceiver circuit coupled to the processor and configured to enable the processor to communicate with a wireless unicast network,
wherein the processor is configured with processor-executable instructions to perform operations further comprising:
determining whether an age of the stored webpage content element exceeds a threshold value prior to generating the requested webpage;
determining whether a unicast network connection is available to the receiver device when it is determined that the age of the stored webpage content exceeds the threshold value;
accessing the requested website via the unicast network connection when it is determined that a unicast network connection is available to the receiver device;
downloading an updated webpage content element from the requested website via the unicast network connection; and
storing the updated webpage content element in the memory of the receiver device,
wherein the processor is configured with processor-executable instructions to perform operations such that generating the requested webpage in the web server application operating in the receiver device using the stored webpage content element uses a most recently stored webpage content element.

62. A receiver device, comprising:
means for receiving in the receiver device a broadcast content description message describing a content element and identifying a time at which a package including the content element will be broadcast;
means for determining in the receiver device from at least some of the information included in the received content description message whether the package including the content element should be received;
means for receiving the package including the content element at the identified broadcast time when it is determined that the content element should be received;
means for storing the received content in memory of the receiver device;
means for receiving a request to access the content in the receiver device; and
means for rendering the requested content using an application resident in the receiver device.

63. The receiver device of claim 62, wherein:
means for receiving a request to access the content in the receiver device comprises receiving a request to access a webpage in the receiver device; and
means for rendering the requested content using an application resident in the receiver device comprises:
means for generating the requested webpage in a web server application operating in the receiver device using the stored webpage content element; and
means for providing the generated requested webpage to a web browser operating in the receiver device.

64. The receiver device of claim 63, wherein means for generating the requested webpage comprises:
means for obtaining a template for the requested webpage from memory in the receiver device; and
means for applying in the receiver device to the obtained template to the stored webpage content element.

65. The receiver device of claim 64, further comprising means for receiving the template for the requested webpage from the broadcast network and storing the received template in memory in the receiver device.

66. The receiver device of claim 63, wherein means for generating the requested webpage comprises:
means for loading from memory in the receiver device a program for execution on the web server of the receiver device, the program configured to generate the requested webpage according to logic implemented in the program; and
means for processing the stored webpage content element in the program.

67. The receiver device of claim 66, further comprising means for receiving the program for the requested webpage from the broadcast network and storing the received template in memory in the receiver device.

68. The receiver device of claim 63, wherein means for determining whether the package including the webpage content element should be received comprises means for determining whether the package including the webpage content element should be received based at least in part upon an identifier associated with the webpage content element.

69. The receiver device of claim 68, further comprising:
means for receiving a user request to access a website; and
means for using an identifier of the requested website as the identifier associated with the webpage content element for determining whether the package including the webpage content element should be received.

70. The receiver device of claim 69, wherein the identifier associated with the webpage content element is not an Internet URL for the requested website.

71. The receiver device of claim 68, further comprising:
means for receiving a user request to access a web flow of the broadcast network broadcasting content of the requested website; and
means for using an identifier of the requested web flow as the identifier associated with the webpage content element for determining whether the package including the webpage content element should be received.

72. The receiver device of claim 68, further comprising:
means for determining in the receiver device from at least some of the information included in the received content description message a version of the webpage content element that will be broadcast; and
means for comparing the version of the webpage content element that will be broadcast to a version of a webpage content element stored in memory of the receiver device,
wherein means for determining whether the package including the webpage content element should be received comprises means for determining whether the package including the webpage content element should be received based at least in part upon whether the version of the webpage content element that will be broadcast is newer than the version of the webpage content element stored in memory of the receiver device.

73. The receiver device of claim 68, wherein the webpage content element includes an address for accessing the requested website via a network which may be different from the identifier of the requested web flow, the receiver device further comprising:
means for determining whether a unicast network connection is available to the receiver device;
means for accessing a remote server supporting the requested website via the unicast network connection when it is determined that a unicast network connection is available to the receiver device;
means for requesting a download of webpage content elements; and
means for storing webpage content elements received from the requested website via the unicast network connection.

74. The receiver device of claim 73, further comprising:
means for requesting from the remote server supporting the requested website a list of webpages available at the requested website when it is determined that a unicast network connection is available to the receiver device;
means for generating and displaying in the receiver device a list of webpages corresponding to the requested website;
means for receiving a user input selecting one of the listed webpages; and
means for determining whether the selected one of the listed webpages is supported by webpage elements stored in memory of the receiver device,
wherein means for requesting a download of webpage content elements comprises means for requesting a download of webpage content elements when it is determined that the selected one of the listed webpages is supported by webpage elements stored in memory of the receiver device.

75. The receiver device of claim 74, wherein means for requesting from the remote server supporting the requested website a list of webpages available at the requested website comprises:
means for transmitting to the remote server supporting the requested website a list of webpages supported by webpage elements stored in memory of the receiver device; and
means for receiving from the remote server via the unicast network a list of missing webpages which are available at the requested website but not included in the list of webpages supported by webpage elements stored in memory of the receiver device,
wherein means for generating and displaying in the receiver device a list of webpages corresponding to the requested website comprises means for generating the list of webpages corresponding to the requested website based on a combination of the list of webpages supported by webpage elements stored in memory of the receiver device and the list of missing received webpages.

76. The receiver device of claim 71, wherein the identifier associated with the webpage content element comprises a web flow identifier.

77. The receiver device of claim 76, further comprising:
means for determining whether a unicast network connection is available to the receiver device;
means for accessing a web content server of the broadcast network via the unicast network connection when it is determined that a unicast network connection is available to the receiver device;
means for requesting a download of webpage content elements associated with the requested web flow from the web content server; and
means for storing webpage content elements received from the web content server via the unicast network connection.

78. The receiver device of claim 66, wherein the program for the requested webpage includes an address of a remote server which may be contacted via a network, wherein the address of a remote server is different from the web flow identifier.

79. The receiver device of claim 63, further comprising:
determining whether an age of the stored webpage content element exceeds a threshold value prior to generating the requested webpage;
means for determining whether a unicast network connection is available to the receiver device when it is determined that the age of the stored webpage content exceeds the threshold value;
means for accessing the requested website via the unicast network connection when it is determined that a unicast network connection is available to the receiver device;
means for downloading an updated webpage content element from the requested website via the unicast network connection; and
means for storing the updated webpage content element in the memory of the receiver device,
wherein means for generating the requested webpage in the web server application operating in the receiver device using the stored webpage content element comprises means for generating the requested webpage in the web server application operating in the receiver device using the stored webpage content element using a most recently stored webpage content element.

80. A non-transitory processor-readable storage medium having stored thereon processor-executable instructions configured to cause a processor of a receiver device to perform operations comprising:
receiving in the receiver device a broadcast content description message describing a content element and identifying a time at which a package including the content element will be broadcast;
determining in the receiver device from at least some of the information included in the received content description message whether the package including the content element should be received;
receiving the package including the content element at the identified broadcast time when it is determined that the content element should be received;
storing the received content in memory of the receiver device;
receiving a request to access the content in the receiver device; and
rendering the requested content using an application resident in the receiver device.

81. The non-transitory processor-readable storage medium of claim 80, wherein the stored processor-executable instructions are configured to cause a processor of a receiver device to perform operations such that:
receiving a request to access the content in the receiver device comprises receiving a request to access a webpage in the receiver device; and
rendering the requested content using an application resident in the receiver device comprises:
generating the requested webpage in a web server application operating in the receiver device using the stored webpage content element; and
providing the generated requested webpage to a web browser operating in the receiver device.

82. The non-transitory processor-readable storage medium of claim 81, wherein the stored processor-executable instructions are configured to cause a processor of a receiver device to perform operations such that generating the requested webpage comprises:
obtaining a template for the requested webpage from memory in the receiver device; and
applying in the receiver device to the obtained template to the stored webpage content element.

83. The non-transitory processor-readable storage medium of claim 82, wherein the stored processor-executable instructions are configured to cause a processor of a receiver device to perform operations further comprising receiving the template for the requested webpage from the broadcast network and storing the received template in memory in the receiver device.

84. The non-transitory processor-readable storage medium of claim 81, wherein the stored processor-executable instructions are configured to cause a processor of a receiver device to perform operations such that generating the requested webpage comprises:
loading from memory in the receiver device a program for execution on the web server of the receiver device, the program configured to generate the requested webpage according to logic implemented in the program; and
processing the stored webpage content element in the program.

85. The non-transitory processor-readable storage medium of claim 84, wherein the stored processor-executable instructions are configured to cause a processor of a receiver device to perform operations further comprising receiving the program for the requested webpage from the broadcast network and storing the received template in memory in the receiver device.

86. The non-transitory processor-readable storage medium of claim 81, wherein the stored processor-executable instructions are configured to cause a processor of a receiver device to perform operations such that determining whether the package including the webpage content element should be received is based at least in part upon an identifier associated with the webpage content element.

87. The non-transitory processor-readable storage medium of claim 86, wherein the stored processor-executable instructions are configured to cause a processor of a receiver device to perform operations further comprising:
receiving a user request to access a website; and
using an identifier of the requested website as the identifier associated with the webpage content element for determining whether the package including the webpage content element should be received.

88. The non-transitory processor-readable storage medium of claim 87, wherein the identifier associated with the webpage content element is not an Internet URL for the requested website.

89. The non-transitory processor-readable storage medium of claim 87, wherein the stored processor-executable instructions are configured to cause a processor of a receiver device to perform operations further comprising:
receiving a user request to access a web flow of the broadcast network broadcasting content of the requested website; and
using an identifier of the requested web flow as the identifier associated with the webpage content element for determining whether the package including the webpage content element should be received.

90. The non-transitory processor-readable storage medium of claim 86, wherein the stored processor-executable instructions are configured to cause a processor of a receiver device to perform operations further comprising:
determining in the receiver device from at least some of the information included in the received content description message a version of the webpage content element that will be broadcast; and
comparing the version of the webpage content element that will be broadcast to a version of a webpage content element stored in memory of the receiver device,
wherein the stored processor-executable instructions are configured to cause a processor of a receiver device to perform operations such that determining whether the package including the webpage content element should be received is based at least in part upon whether the version of the webpage content element that will be broadcast is newer than the version of the webpage content element stored in memory of the receiver device.

91. The non-transitory processor-readable storage medium of claim 86, wherein the stored processor-executable instructions are configured to cause a processor of a receiver device to perform operations such that the webpage content element includes an address for accessing the requested website via a network which may be different from the identifier of the requested web flow, and wherein the stored processor-executable instructions are configured to cause a processor of a receiver device to perform operations further comprising:
determining whether a unicast network connection is available to the receiver device;
accessing a remote server supporting the requested website via the unicast network connection when it is determined that a unicast network connection is available to the receiver device;
requesting a download of webpage content elements; and
storing webpage content elements received from the requested website via the unicast network connection.

92. The non-transitory processor-readable storage medium of claim 91, wherein the stored processor-executable instructions are configured to cause a processor of a receiver device to perform operations further comprising:
requesting from the remote server supporting the requested website a list of webpages available at the requested website when it is determined that a unicast network connection is available to the receiver device;
generating and displaying in the receiver device a list of webpages corresponding to the requested website;
receiving a user input selecting one of the listed webpages; and
determining whether the selected one of the listed webpages is supported by webpage elements stored in memory of the receiver device,
wherein the stored processor-executable instructions are configured to cause a processor of a receiver device to perform operations such that requesting a download of webpage content elements is accomplished when it is determined that the selected one of the listed webpages is supported by webpage elements stored in memory of the receiver device.

93. The non-transitory processor-readable storage medium of claim 92, wherein the stored processor-executable instructions are configured to cause a processor of a receiver device to perform operations such that requesting from the remote server supporting the requested website a list of webpages available at the requested website comprises:
transmitting to the remote server supporting the requested website a list of webpages supported by webpage elements stored in memory of the receiver device; and
receiving from the remote server via the unicast network a list of missing webpages which are available at the requested website but not included in the list of webpages supported by webpage elements stored in memory of the receiver device,
wherein the stored processor-executable instructions are configured to cause a processor of a receiver device to perform operations such that generating and displaying in the receiver device a list of webpages corresponding to the requested website comprises generating the list of webpages corresponding to the requested website based on a combination of the list of webpages supported by webpage elements stored in memory of the receiver device and the list of missing received webpages.

94. The non-transitory processor-readable storage medium of claim 89, wherein the identifier associated with the webpage content element comprises a web flow identifier.

95. The non-transitory processor-readable storage medium of claim 94, wherein the stored processor-executable instructions are configured to cause a processor of a receiver device to perform operations further comprising:
determining whether a unicast network connection is available to the receiver device;
accessing a web content server of the broadcast network via the unicast network connection when it is determined that a unicast network connection is available to the receiver device;
requesting a download of webpage content elements associated with the requested web flow from the web content server; and
storing webpage content elements received from the web content server via the unicast network connection.

96. The non-transitory processor-readable storage medium of claim 84, wherein the program for the requested webpage includes an address of a remote server which may be contacted via a network, wherein the address of a remote server is different from the web flow identifier.

97. The non-transitory processor-readable storage medium of claim 81, wherein the stored processor-executable instructions are configured to cause a processor of a receiver device to perform operations further comprising:
determining whether an age of the stored webpage content element exceeds a threshold value prior to generating the requested webpage;
determining whether a unicast network connection is available to the receiver device when it is determined that the age of the stored webpage content exceeds the threshold value;
accessing the requested website via the unicast network connection when it is determined that a unicast network connection is available to the receiver device;
downloading an updated webpage content element from the requested website via the unicast network connection; and
storing the updated webpage content element in the memory of the receiver device,
wherein the stored processor-executable instructions are configured to cause a processor of a receiver device to perform operations such that generating the requested webpage in the web server application operating in the receiver device using the stored webpage content element uses a most recently stored webpage content element.
